(19) United States
(12) Patent Application Publication
(10) Pub. No.: US 2026/0006655 A1
(43) Pub. Date: Jan. 1, 2026

(54) SYSTEMS AND METHODS FOR DATA PLANE ARCHITECTURE OF A WIRELESS COMMUNICATION SYSTEM

(71) Applicant: Huawei Technologies Co., Ltd., Shenzhen (CN)

(72) Inventors: Xu Li, Nepean (CA); Chenchen Yang, Ottawa (CA); Weisen Shi, Kanata (CA); Hang Zhang, Ottawa (CA)

(21) Appl. No.: 19/302,747

(22) Filed: Aug. 18, 2025

Related U.S. Application Data
(63) Continuation of application No. PCT/CN2023/077507, filed on Feb. 21, 2023.

(51) Int. Cl. H04W 76/12; H04W 28/06

(52) U.S. Cl. CPC H04W 76/12; H04W 28/065

(57) ABSTRACT

The disclosure provides for systems and methods for data plane architecture of a wireless communication system. According to an aspect a method is provided. The method may include receiving, by at least one DP GW from a caller, a request based on a first service-based interface format of the caller. The request may indicate one or more of: a procedure to be performed by a callee and a parameter of the procedure. The method may further include sending, by the at least one DP GW to the callee, a second request based on a second service-based interface format of the callee, the second request indicating one or more of: the procedure and the one or more parameters of the procedure.

### CROSS-REFERENCE TO RELATED APPLICATION

This application is a continuation of International Application No. PCT/CN2023/077507, filed on Feb. 21, 2023, the disclosure of which is hereby incorporated by reference in its entirety.

### TECHNICAL FIELD

The present disclosure pertains to the field of communication networks, and in particular to systems and methods for data plane architecture of a wireless communication system.

### BACKGROUND

Existing wireless communication systems, such as 5G or 4G, offer data connectivity services to user equipment (UE), where packet encapsulation is performed to support data communication. During data communication, tunnel headers may be added to and removed from the protocol data units (PDUs), which may cause communication overhead. Such overheads are undesirable in future wireless communication systems.

Future wireless communication systems are anticipated to offer data processing services. Traditionally, a data processing service is provided and managed by an entity outside the wireless communication system. As a result, assuring end-to-end performance, e.g., data rate, delay, etc. may be difficult to maintain. How such data processing services may be provided in future wireless communication systems are yet to be determined.

Therefore, there is a need for systems and methods for data plane architecture of a wireless communication system that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The disclosure provides for systems and methods for data plane architecture of a wireless communication system. According to an aspect, a method is provided. The method includes receiving, by at least one data plane (DP) gateway (GW) from a caller, a request based on a first service-based interface format of the caller. The request indicating one or more of: a procedure to be performed by a callee and a parameter of the procedure. The method further includes sending, by the at least one DP GW to the callee, a second request based on a second service-based interface format of the callee, the second request indicating one or more of: the procedure and the one or more parameters of the procedure.

The method may further include mapping, by the at least one DP GW, the request to the second request. Receiving, by the at least one DP GW from the caller, the request may include receiving, by the at least one DP GW from the caller, at least one PDU including the request.

Mapping, by the at least one DP GW, the request to the second request may include: mapping, by a first DP GW of the at least one DP GW, the request to the second request. Sending, by the at least one DP GW to the callee, a second request may include sending, by the first DP GW to a second DP GW of the at least one DP GW, the at least one PDU including the second request.

Mapping, by the at least one DP GW, the request to the second request may include sending, by a first DP GW of the at least one DP GW to a second DP GW of the at least one DP GW, the at least one PDU including the request. Mapping, by the at least one DP GW, the request to the second request may further include mapping, by the second DP GW, the request to the second request.

Sending, by the first DP GW to the second DP GW, the at least one PDU may include segmenting, by the first DP GW, the request into multiple request segments. Sending, by the first DP GW to the second DP GW, the at least one PDU may further include sending, by the first DP GW to the second DP GW, multiple PDUs including the multiple request segments.

Mapping, by the second DP GW, the request to the second request further may include reassembling, by the second DP GW, the multiple PDUs to obtain the request.

The request may include a first set of identifiers (IDs) based on the first service-based interface format of the caller, the first set of IDs indicating one or more of: the procedure, and the parameter of the procedure. The second request may include a second set of IDs based on the second service-based interface format of the callee, the second set of IDs indicating one or more of: the procedure, and the parameter of the procedure.

The method may further include receiving, by the least one DP GW from the callee, a response based on the second service-based interface format, the response indicating one or more of: a result of the procedure and a result value. The method may further include sending, by the at least one DP GW to the caller, a second response based on the first service-based interface format, the response indicating one or more of: the result of the procedure and the result value. The method may further include mapping, by the at least one DP GW, the response to the second response.

Receiving, by the least one DP GW from the caller, a response may include receiving, by the at least one DP GW from the callee, at least one PDU including the response.

Mapping, by the at least one DP GW, the response to the second response may include mapping, by a third DP GW of the at least one DP GW, the response to the second response. Sending, by the at least one DP GW to the caller, the second response may include sending, by the third DP GW to a fourth DP GW of the at least one DP GW, the at least one PDU including the second response.

Mapping, by the at least one DP GW, the response to the second response may include sending, by a third DP GW of the at least one DP GW to a fourth DP GW of the at least one DP GW, the at least one PDU including the response. Mapping, by the at least one DP GW, the response to the second response may further include mapping, by the fourth DP GW, the response to the second response.

Sending, by the third DP GW to the fourth DP GW, the at least one PDU may include segmenting, by the third DP GW, the response into multiple response segments. Sending, by the third DP GW to the fourth DP GW, the at least one PDU may further include sending, by the third DP GW to the fourth DP GW, multiple PDUs including the multiple response segments.

Mapping, by the fourth DP GW, the response to the second response may further include reassembling, by the second DP GW, the multiple PDUs to obtain the request.

The response may include a third set of IDs based on the second service-based interface format of the callee, the third set of IDs indicating one or more of: the result of the procedure. The second response may include a fourth set of IDs based on the first service-based interface format of the caller, the fourth set of IDs indicating one or more of: the result of the procedure.

According to another aspect, another method is provided. The method includes receiving, by a data plane (DP) gateway (GW) from a first network entity, via a receiving tunnel, a PDU associated with a service, the PDU to be routed via a second network entity. The method further includes processing, by the DP GW, the PDU based on the service. The method further includes sending, by the DP GW, the PDU to the second network entity.

The PDU may include a first L3 header, the first L3 header including one or more of: a source address; a destination address; and a quality of service (QOS) information indicating one of: a class of the PDU, a priority of the PDU; and a QoS flow that the PDU belongs to.

The source address may indicate one of: an address of a sender of the PDU, an address of a radio access network (RAN) node to which the sender belongs to, an address of an originator of the PDU, and an address of a processing service. The destination address is one of: an address of the DP GW, an address of a RAN node to which the DP GW belongs to, and an address of a processing service.

The PDU may further include a first L4 header, the first l4 header including a connection identifier (ID) identifying the receiving tunnel through which the PDU is received.

The receiving tunnel may be associated with a processing service, the connection ID identifying a connection between an originator of the PDU and a final destination of the PDU. The receiving tunnel may be associated with a connectivity service that connects two network entities, the connection ID identifying a connection between the two network entities.

Sending, by the DP GW, the PDU to the second network entity may include determining, by the DP GW, a transmitting tunnel. Sending, by the DP GW, the PDU to the second network entity may further include sending, by the DP GW, the PDU to the second network entity via the transmitting tunnel.

The transmitting tunnel may be determined based on one of: a mapping between the receiving tunnel and the transmitting tunnel, a mapping between the connection ID and a second connection ID that identifies the transmitting tunnel, a mapping among the connection ID, the QoS information and the second connection ID, and a mapping provided by a network controller at the RAN.

The transmitting tunnel may include a sender end and a receiver end, the sender end being the DP GW and the receiver end being the second network entity.

The DP GW may be a central unit (CU) in a RAN DP. The PDU may be associated with a processing service. The receiving tunnel may be a T3 tunnel. The transmitting tunnel may be an M2 tunnel. The receiver end of the transmitting tunnel may be a RAN DP GW.

The PDU may be associated with a processing service. The receiving tunnel may be an M2 tunnel. The transmitting tunnel may be a T3 tunnel. The receiver end of the transmitting tunnel may be a core network (CN) DP GW.

The PDU may be associated with a connectivity service. The receiving tunnel may be a T3 tunnel. The transmitting tunnel may be a data radio bearer (DRB) associated with a device. The receiver end of the transmitting tunnel may be the device.

The DP GW may be a processing unit (PU) in a RAN DP and the PDU may be associated with a processing service. The receiving tunnel may be one of: a T3 tunnel, an M2 tunnel, an M5 tunnel. The transmitting tunnel may be an M4 tunnel. The receiver end of the transmitting tunnel may be a RAN DP GW.

The receiving tunnel may be one of: a T3 tunnel, an M2 tunnel, an M4 tunnel, and an M5 tunnel. The transmitting tunnel may be a processing radio bearer (XRB) associated with a device. The receiver end of the transmitting tunnel may be the device.

The receiving tunnel may be one of: a T3 tunnel, an M2 tunnel, and an M4 tunnel. The transmitting tunnel may be an M5 tunnel. The receiver end of the transmitting tunnel may be a RAN processing service function (PSF).

The method may further include processing, by the DP GW, the PDU to obtain a modified PDU. Sending, by the DP GW, the PDU to the second network entity via the transmitting tunnel may include sending, by the DP GW, the modified PDU to the second network entity via the transmitting tunnel.

Processing, by the DP GW, the PDU to obtain a modified PDU may include one of: replacing the first L3 header with a second L3 header, modifying the first L3 header into the second L3 header. The second L3 header may include one or more of: a second source address, a second destination address, a second QoS information.

The second source address may be one of: a same address as the source address in the first L3 header, a different address than the source address in the first L3 header, an address of a RAN DP GW, an address of a processing service from which the PDU originated.

The second destination address may be one of: a same address as the destination address in the first L3 header; a different address than the destination address in the first L3 header; an address of the receiving end of the transmitting tunnel; an address of a processing service wherein the PDU is targeting the processing service; an address of a device wherein the transmitting tunnel is a radio bearer associated with the device.

The second QoS information may be is one of: the same as the QoS information in the first L3 header, different from the QoS information in the first L3 header.

Processing, by the DP GW, the PDU to obtain a modified PDU further may include one of: replacing the first LA header with a second L4 header, and modifying the first L4 header into the second L4 header. The second L4 header may include a third connection ID, the third connection ID being one or more of: different from the connection ID in the first L4 header; an ID identifying the transmitting tunnel; and the second connection ID.

The transmitting tunnel may be associated with a processing service, the third connection ID identifies a connection between an originator of the PDU and a final destination of the PDU. The transmitting tunnel may be associated with a connectivity service that connects two network entities, the connection ID identifies a connection between the two network entities.

The receiving tunnel may be a radio bearer associated with a device, the radio bearer being one of: a data radio bearer (DRB) and a processing radio bearer (XRB). The PDU may include a first L3 header, the first L3 header including one or more of: a source address; a destination address; and a quality of service (QOS) information indicating one of: a class of the PDU, a priority of the PDU and a QoS flow that the PDU belongs to.

The source address may indicate an address of an originator of the PDU, the originator being the device. In some cases, the destination address may be one of: an address of a processing service or an address of a processing service function (PSF) that provides at least part of the processing service if: the receiving tunnel is associated with the processing service, the receiving tunnel is the XRB, or the PDU is targeting the processing service. In some cases, the destination address may be one of: an address of the DP GW or an address of a radio access network (RAN) node to which the DP GW belongs to.

The method may further include a first L4 header, the first l4 header including a connection identifier (ID) identifying the receiving tunnel through which the PDU is received.

The connection ID may identify a connection between the device and: a processing service or a PSF that provides at least part of the processing service if: the receiving tunnel is associated with a processing service, the receiving tunnel is the XRB that the device uses to access the processing service, or the PDU is associated with the processing service.

The connection ID may identify a connection between the device and: a data network (DN) or an application server of the DN if: the receiving tunnel is associated with a connectivity service, the receiving tunnel is a DRB that the device uses to access the connectivity service, or the PDU is associated with the connectivity service, wherein the connectivity service connects the device to the DN or the AS.

Sending, by the DP GW, the PDU to the second network entity may include determining, by the DP GW, a transmitting tunnel. Sending, by the DP GW, the PDU to the second network entity may further include sending, by the DP GW, the PDU to the second network entity via the transmitting tunnel.

The transmitting tunnel may be determined based on one of: a mapping between the receiving tunnel and the transmitting tunnel, a mapping between the connection ID and a second connection ID that identifies the transmitting tunnel, a mapping among the connection ID, the QoS information and the second connection ID, and a mapping provided by a network controller at the RAN.

The transmitting tunnel may include a sender end and a receiver end, the sender end being the DP GW. The DP GW may be a central unit (CU) in a RAN DP. The PDU may be associated with a connectivity service. The transmitting tunnel may be a T3 tunnel. The receiver end of the transmitting tunnel may be a core network (CN) DP GW in a CN DP. The second network entity may be the receiver end of the transmitting tunnel.

The DP GW may be a processing unit (PU) in a RAN DP. Where the PDU is associated with a processing service, the transmitting tunnel may be one of: an M2 tunnel, an M4 tunnel, or an M5 tunnel.

Where the transmitting tunnel is a T3 tunnel, the receiver end of the transmitting tunnel may be a core network (CN) DP GW in a CN DP, and the second network entity is the receiver end of the transmitting tunnel.

Where the transmitting tunnel is an M2 tunnel, the receiving end of the transmitting tunnel is a central unit (CU) in the RAN DP, and the second network entity is the receiver end of the transmitting tunnel.

Where the transmitting tunnel is an M4 tunnel, the receiver end of the transmitting tunnel may be another PU, and the another PU is communicatively coupled with a processing service function (PSF) in the RAN that provides at least in part the processing service. Where the transmitting tunnel is an M4 tunnel, the second network entity may be the receiver end of the transmitting tunnel.

Where the transmitting tunnel is an M5 tunnel, the receiver end of the transmitting tunnel may be a RAN processing service function (PSF), the RAN PSF providing at least in part the processing service. Where the transmitting tunnel is an M5 tunnel, the second network entity is the receiver end of the transmitting tunnel.

The method may further include processing, by the DP GW, the PDU to obtain a modified PDU. Sending, by the DP GW, the PDU to the second network entity via the transmitting tunnel may include sending, by the DP GW, the modified PDU to the second network entity via the transmitting tunnel.

Processing, by the DP GW, the PDU to obtain a modified PDU may include one of: replacing the first L3 header with a second L3 header, and modifying the first L3 header into the second L3 header. The second L3 header may include a second source address, the second source address being one of: a same address as the source address in the first L3 header, a different address than the source address in the first L3 header, an address of the DP GW.

The second L3 header may further include a second destination address, the second destination address being one of: a same address as the destination address in the first L3 header, a different address than the destination address in the first L3 header, an address of the receiving end of the transmitting tunnel, an address of a processing service function that provides at least part of a processing service wherein the PDU is targeting the processing service.

The second L3 header may further include a second QoS information, the second QoS information being one of: the same as the QoS information in the first L3 header, different from the QoS information in the first L3 header.

Processing, by the DP GW, the PDU to obtain a modified PDU may further includes one of: replacing the first L4 header with a second L4 header, modifying the first L4 header into the second L4 header. The second L4 header may be a tunnel header of the transmitting tunnel.

The second L4 header may include a third connection ID, the third connection ID being one or more of: different from the connection ID in the first L4 header; an ID identifying the transmitting tunnel; and the second connection ID.

Where the DP GW is a core network (CN) DP GW, a receiver end of the receiving tunnel may be the CN DP GW, and a sender end of the receiving tunnel may be at one of: a radio access network (RAN), a CN, and a data network (DN).

The PDU may include a first L3 header, the first L3 header including one or more of: a source address and a destination address. The source address may indicate one of: an address of the sender end, an address of a radio access network (RAN) node to which the sender end belongs, an address of an originator, and an address of a processing service from where the PDU originated.

The destination address may be one of: an address of the CN DP GW, and an address of a processing service if the PDU is targeting the processing service.

The PDU may further include a quality of service (QOS) information indicating one of: a class of the PDU, a priority of the PDU, and a QoS flow that the PDU belongs to.

The PDU may further include a first L4 header, the first l4 header including a connection identifier (ID) identifying a receiving tunnel through which the PDU is received.

The connection ID may identify a connection between the originator of the PDU and a final destination of the PDU if: the receiving tunnel is associated to a processing service or the PDU is associated to a processing service. In some cases, the connection ID may identify a connection between two network entities if: the receiving tunnel or the PDU is associated with a connectivity service, the connectivity service connecting the two network entities.

Sending, by the DP GW, the PDU to the second network entity may include determining, by the CN DP GW, a transmitting tunnel. Sending, by the DP GW, the PDU to the second network entity may further include sending, by the CN DP GW, the PDU to the second network entity via the transmitting tunnel.

The transmitting tunnel may be determined based on one of: a mapping between the receiving tunnel and the transmitting tunnel, a mapping between the connection ID and a second connection ID that identifies the transmitting tunnel, a mapping among the connection ID, the QoS information and the second connection ID, and a mapping provided by a network controller at the CN.

The transmitting tunnel may include a sender end and a receiver end, the sender end being the CN DP GW, the receiver end being in one of: the RAN, the CN, and the DN.

Where the transmitting tunnel is a T3 tunnel, the receiver end of the transmitting tunnel may be a RAN DP GW in a RAN DP, and the second network entity is the receiver end of the transmitting tunnel.

Where the transmitting tunnel is a T4 tunnel, the receiver end of the transmitting tunnel is another CN DP GW in a RAN DP, and the second network entity is the receiver end of the transmitting tunnel.

Where the PDU is associated with a processing service and the transmitting tunnel is a T5 tunnel, the receiver end of the transmitting tunnel may be a CN processing service function (PSF) that provides at least in part the processing service. In such cases, the second network entity may be the receiver end of the transmitting tunnel.

Where the transmitting tunnel is a T6 tunnel, the receiver end of the transmitting tunnel is in a DN, and the second network entity may be the receiver end of the transmitting tunnel.

The method may further include processing, by the CN DP GW, the PDU to obtain a modified PDU. Sending, by the CN DP GW, the PDU to the second network entity via the transmitting tunnel may include: sending, by the CN DP GW, the modified PDU to the second network entity via the transmitting tunnel.

Processing, by the CN DP GW, the PDU to obtain a modified PDU includes one of: replacing the first L3 header with a second L3 header, modifying the first L3 header into the second L3 header.

The second L3 header may include a second source address, the second source address being one of: a same address as the source address in the first L3 header, a different address than the source address in the first L3 header, an address of the CN DP GW, an address of an originator of the PDU, and an address of a processing services if the PDU originated from a processing service.

The second L3 header may further include a second destination address, the second destination address being one of: a same address as the destination address in the first L3 header, a different address than the destination address in the first L3 header, an address of the receiving end of the transmitting tunnel, an address of a processing service function that provides at least part of a processing service if the PDU is targeting the processing service.

The second L3 header may further include a second QoS information, the second QoS information being one of: the same as the QoS information in the first L3 header or different from the QoS information in the first L3 header.

Processing, by the CN DP GW, the PDU to obtain a modified PDU may further include replacing the first L4 header with a second L4 header. In some cases, Processing, by the CN DP GW, the PDU to obtain a modified PDU may further include modifying the first L4 header into the second LA header, where the second L4 header is a tunnel header of the transmitting tunnel.

The second L4 header may include a third connection ID, the third connection ID being one or more of: different from the connection ID in the first L4 header, an ID identifying the transmitting tunnel, and the second connection ID.

The third connection ID may identify a connection between an originator of the PDU and a final destination of the PDU if: the transmitting tunnel or the PDU is associated with a processing service. In some cases, the third connection ID may identify a connection between two network entities if: the transmitting tunnel or the PDU is associated with a connectivity service that connects the two network entities.

According to another aspect, another method is provided. The method includes receiving, by a first network controller at a radio access network (RAN) from a second network controller at a core network (CN), information about a device, the information indicating one or more of: a process radio bearer (XRB) is needed for a device, and the device is accessing a processing service. The method further includes allocating, by the first network controller, the XRB based on the information about the device. The method further includes configuring, by the first network controller, one or more network nodes to support the XRB.

Allocating, by the first network controller, the XRB based on the information about the device may include generating an identifier (ID) to identify the XRB.

Configuring, by the first network controller, one or more network nodes to support the XRB may include configuring, by the first network controller, a RAN data plane (DP) gateway (GW) associated with the XRB.

Where the RAN DP GW is a processing unit (PU), configuring, by the first network controller, the RAN DP GW may include: providing, by the first network controller to the PU, the generated ID. configuring, by the first network controller, the RAN DP GW may further include configuring, by the first network controller, the PU to disable the XRB to perform one or more of: PDCP security, and PDCP sequencing.

Configuring, by the first network controller, one or more network nodes to support the XRB may further include configuring, by the first network controller, a distributed unit (DU) associated with the XRB.

Configuring, by the first network controller, the DU associated with the XRB may include providing, by the first network controller to the DU, the generated ID. Configuring, by the first network controller, the DU associated with the XRB may further include configuring, by the first network controller, the DU to disable the XRB to perform one or more of: RLC segmentation, and RLC acknowledgement.

Configuring, by the first network controller, one or more network nodes to support the XRB may further includes configuring, by the first network controller, the device to support the XRB.

Configuring, by the first network controller, the device to support the XRB may include providing, by the first network controller to the device, the generated ID. Configuring, by the first network controller, the device to support the XRB may further include configuring, by the first network controller, the device to disable the XRB to perform one or more of: RLC segmentation, RLC acknowledgement, PDCP security, and PDCP sequencing.

According to an aspect, another method is provided. The method includes receiving, by a processing unit (PU) in a radio access network (RAN) data plane (DP) from a first network node, via a first interface between the PU and the network node, a protocol data unit (PDU) associated with a service. The method may further include processing, by the PU, the PDU to obtain a processed PDU. The method may further include sending, by the PU to a second network node, via a second interface between the PU and the second network node, the processed PDU.

Where the first network node is the device, and the first interface may be one of: a data radio bearer and a processing radio bearer.

The second network node and the second interface may respectfully be another PU in the RAN DP and an M4 interface. In some cases, the second network node and the second interface may respectfully be a PU backend in the RAN DP and an M5 interface. In some cases, the second network node and the second interface may respectfully be a central unit (CU) in the RAN DP and an M2 interface. In some cases, the second network node and the second interface may respectfully be a DP gateway (GW) in a core network (CN) DP and a T3 interface.

Where the first network node is another PU in the RAN DP, the first interface may be an M4 interface. The second network node and the second interface may be respectfully one of: the device and a data radio bearer, the device and a processing radio bearer, a PU backend in the RAN DP and an M5 interface, a central unit (CU) in the RAN DP and an M2 interface, and a DP gateway (GW) in a core network (CN) DP and a T3 interface.

In some cases, the first network node is a PU backend in the RAN DP, and the first interface is an M5 interface. The second network node and the second interface may respectfully be one of: the device and a data radio bearer, the device and a processing radio bearer, another PU in the RAN DP and an M4 interface, a central unit (CU) in the RAN DP and an M2 interface, and a DP gateway (GW) in a core network (CN) DP and a T3 interface.

In some cases, the first network node is a central unit (CU) in the RAN DP, and the first interface is an M2 interface. The second network node and the second interface may respectfully be one of: the device and a data radio bearer, the device and a processing radio bearer, another PU in the RAN DP and an M4 interface, a PU backend in the RAN DP and an M5 interface, and a DP gateway (GW) in a core network (CN) DP and a T3 interface.

In some cases, the first network node may be a DP gateway (GW) in a core network (CN) DP, and the first interface is a T3 interface. The second network node and the second interface may respectfully be one of: the device and a data radio bearer, the device and a processing radio bearer, another PU in the RAN DP and an M4 interface, a PU backend in the RAN DP and an M5 interface, and a central unit (CU) in the RAN DP and an M2 interface.

According to another aspect, an apparatus is provided. The apparatus includes modules configured to perform one or more of the methods and systems described herein.

According to one aspect, an apparatus is provided, where the apparatus includes: a memory, configured to store a program; a processor, configured to execute the program stored in the memory, and when the program stored in the memory is executed, the processor is configured to perform one or more of the methods and systems described herein.

According to another aspect, a computer readable medium is provided, where the computer readable medium stores program code executed by a device and the program code is used to perform one or more of the methods and systems described herein.

According to one aspect, a chip is provided, where the chip includes a processor and a data interface, and the processor reads, by using the data interface, an instruction stored in a memory, to perform one or more of the methods and systems described herein.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 illustrates an architecture of a communication system, according to an aspect.

FIG. 2 illustrates a core network (CN) data plane architecture, according to an aspect.

FIG. 3 illustrates a RAN data plane architecture, according to an aspect.

FIG. 4 illustrates another RAN data plane architecture, according to an aspect.

FIG. 5 illustrates an overall data plane architecture, according to an aspect.

FIG. 6 illustrates a remote procedure call (RPC), according to an aspect.

FIG. 7 illustrates a procedure of allocating a radio bearer for a device, according to an aspect.

FIG. 8 illustrates an apparatus that may perform any or all of operations of the above methods and features explicitly or implicitly described herein, according to different aspects of the present disclosure.

FIG. 9 illustrates a method for processing data at a DP GW, according to an aspect.

FIG. 10 illustrates another method for processing data, according to an aspect.

FIG. 11 illustrates a method for allocating a radio bearer for a device, according to an aspect.

FIG. 12 illustrate another method of processing data, according to an aspect.

It will be noted that throughout the appended drawings, like features are identified by like reference numerals.

### DETAILED DESCRIPTION

The disclosure provides for systems and methods for data plane architecture of a wireless communication system. According to an aspect a method is provided for data processing at a data plane (DP) gateway (GW).

The method (e.g., method 900) includes receiving, by at least one DP GW from a caller, a request based on a first service-based interface format of the caller. The request may indicate one or more of: a procedure to be performed by a callee and a parameter of the procedure. The method may further include sending, by the at least one DP GW to the callee, a second request based on a second service-based interface format of the callee, the second request indicating one or more of: the procedure and the one or more parameters of the procedure

According to another aspect, another method for processing data may be provided. The method (e.g., method 1000) includes receiving, by a data plane (DP) gateway (GW) from a first network entity, via a receiving tunnel, a PDU associated with a service, the PDU to be routed via a second network entity. The method further includes processing, by the DP GW, the PDU based on the service. The method further includes sending, by the DP GW, the PDU to the second network entity.

According to another aspect, a method for allocating a radio bearer for a device may be provided. The method (e.g., method 1100) includes receiving, by a first network controller (e.g., network controller 710) at a radio access network (RAN) from a second network controller (e.g., network controller) 712 at a core network (CN), information about a device. The information may indicate one or more of: a process radio bearer (XRB) is needed for a device, and the device is accessing a processing service. In some aspects, the method further includes allocating, by the first network controller, the XRB based on the information about the device. In some aspects, the method further includes configuring, by the first network controller, one or more network nodes to support the XRB.

A data connectivity service (or simply, a connectivity service) provided by a communication system (such as a wireless communication system) is a service that routes or transports data traffic of or from a first network entity to a second network entity. The first network entity may be part of the communication system, for example, a device (such as a first user equipment (UE)), or the first network entity may not be part of the communication system, for example, a first application server (AS) in a data network (DN). The second network entity may be part of the communication system, for example, a second device (such as a second UE), or the second network entity may not be part of the communication system, for example, a second AS in a DN. During the routing of the data traffic, in the data connectivity service, the communication system does not process (e.g., obtain, change or store) content of the data traffic.

A data processing service (or simply, a processing service) provided by a communication system (such as a wireless communication system) to a first network entity may be a service, wherein a second network entity receives data traffic from the first network entity and processes (e.g., obtain, change or store or analyze) content of the data traffic. The first network entity may be part of the communication system, for example, a device (such as a UE), or the first network entity may not be part of the communication system, for example, an AS in a DN. The second network entity may be part of the communication system, e.g., a data plane function (DPF) in the data plane (DP) of the communication system. When providing the data processing service to the first network entity, the communication system (e.g., the second network entity) may generate data traffic and transmit the generated data traffic to the first network entity. A data processing service as described above may also be known as a computing service.

A current or previous wireless communication system such as 5G or 4G offers data connectivity service to UEs, wherein packet encapsulation is performed in the data plane to support communications between UEs or between a UE and a DN (e.g., an AS in the DN). During a communication, a protocol data unit (PDU) that is generated by a UE or by a network entity (such as an AS in a DN that is outside the system) is transported through the data plane of the communication system, and the PDU is routed through one or multiple tunnels in the data plane.

The data plane may be known as the user plane. When the PDU enters a tunnel with a first DPF (such as a first UPF in the 5G) and a second DPF (such as a second UPF in the 5G) being the two tunnel end points, a tunnel header is added by the first DPF to the PDU and the entire PDU is treated as data. The tunnel header includes QoS information. When the PDU leaves the tunnel, the tunnel header is removed by the second DPF. The tunnel header may add additional overhead to the communication.

A future wireless communication system such as 6G may offer data processing services in addition to data connectivity services. Traditionally, a data processing service is managed and offered or provided by an entity outside the communication system, e.g., by an AS or a data center or cloud system located in a DN; and the system provides data connectivity service(s) to a UE such that the UE can use the service(s) to connect and access the data processing service. When the wireless communication system offers or provides a data processing service natively, the data processing service is offered or provided by one or multiple network entities in the data plane of the communication system.

When offering or providing the data processing service, the one or multiple network entities may process content of a communication that is related to the processing service, e.g., data included a PDU, and the communication may not necessarily involve a UE. For example, the communication may be between an AS and the one or multiple network entities, or between a UE and the one or multiple network entities.

Although such data processing services are contemplated in future systems, what the data plane architecture may look like and how the data plane may operate or behave to enable or support the data processing services are unclear and yet to be determined.

In current or previous wireless communication system, packet encapsulation is performed in the data plane. During packet encapsulation, a tunnel header is added to a PDU and the entire PDU is treated as data. The added tunnel header may bring additional communication overhead.

When a processing service is offered by an entity outside a wireless communication the system, the processing service and the wireless communication system are managed separately, likely by different parties. As a result, assuring end-to-end performance (e.g., data rate, delay including both communication delay and computing delay) may be difficult to maintain.

According to an aspect, a data plane (DP) architecture for a future wireless communication system (e.g., 6G) is provided. The DP architecture may enable or support native data processing. Network entities in the DP and their behaviors are described in reference to one or more aspects. The network entities in the DP may be called DPFs. In some aspects, the DPFs may include DP gateways (GWs) and processing service functions (PSFs).

A wireless communication system, to which one or more aspects may apply, may include a radio access network (RAN) and a core network (CN). Aspect of the disclosure may provide for DP GWs, including DP GWs in the RAN (i.e., RAN DP GWs) and DP GWs in the CN (i.e., CN DP GWs). The one or more functionalities of the DP GWs, e.g., header processing functionalities and content processing functionalities, according to one or more aspects are described.

Some aspects may provide for an enhanced data bearer (a processing radio bearer (XRB)) to support a processing serviced offered by the system. According to some aspects, allocation of XRB for a UE to access a processing service offered by the system are described.

According to an aspect, an XRB may have simplified protocol behavior at the RLC and PDCP sub layers (such as no RLC segmentation, no RLC acknowledgement, no PDCP security, no PDCP sequencing) compared to traditional data radio bearer (DRB). In some aspects the protocol behavior of an XRB may exclude one or more of: RLC segmentation, RLC acknowledgement, PDCP security, and PDCP sequencing.

In some aspects, a reference to ‘an entity’ may refer to ‘multiple such entities.’ For example, an existence or inclusion of an entity may indicate existence or inclusion of multiple such entities.

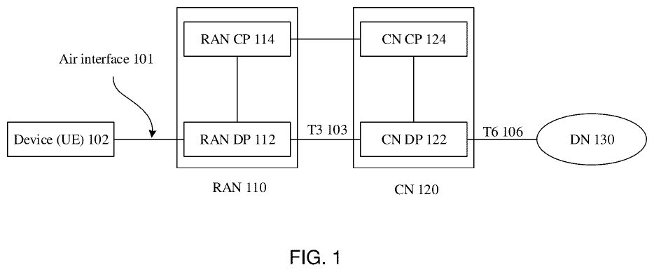

FIG. 1 illustrates an architecture of a communication system, according to an aspect. The communication system may comprise a RAN 110 and a CN 120. The CN 120 may comprise a control plane (CP) 124 and a data plane (DP) 122. The CP of the CN (i.e., CN CP) may comprise one or multiple control plane functions (CPFs). The RAN 110 may also comprise a CP 114 and a DP 112. The CP of the RAN (i.e., RAN CP) may comprise one or multiple centralized units (CUs). To be differentiated from a CU in the DP of the RAN (i.e., RAN DP) described herein, in some aspects, a CU in the RAN CP may be referred to as a CU-CP. The communication system may connect with a DN 130 (i.e., one or multiple DNs). The DN may connect with the DP of the CN (i.e., CN DP 122) via a T6 connection (or interface) 106.

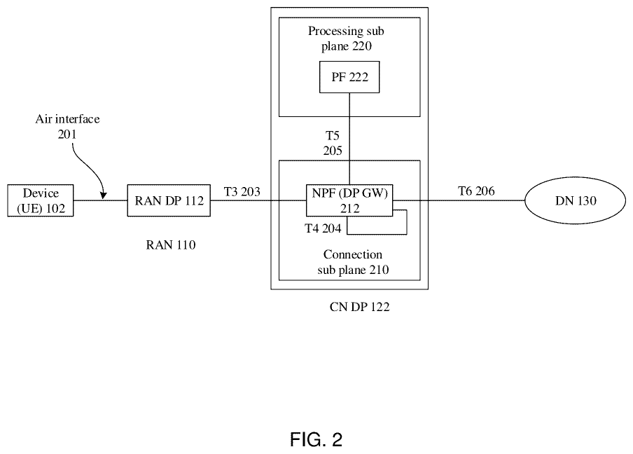

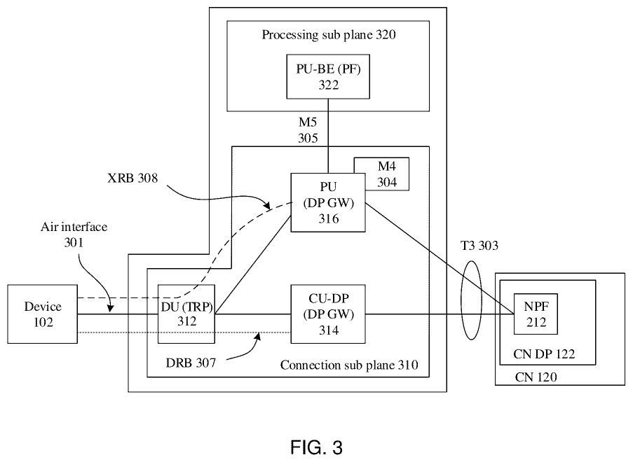

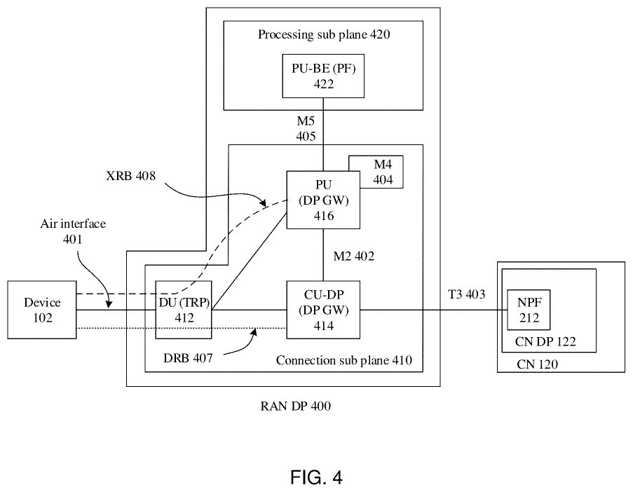

The communication system may further include a device 102 (i.e., one or multiple devices). The device may connect to the DP of the RAN (i.e., RAN DP 112) via an air interface 101. The RAN DP 112 may connect with CN DP 122 via a T3 connection (or interface) 103. Through the RAN DP 112, the device 102 may be further connected to the CN DP 122 such that the device 102 can interact or communicate with a data plane function (DPF), e.g., a processing function (PF) as described herein, in the CN DP 122 or with the DN 130 (e.g., a server in the DN 130) that is connected to the CN DP 122 via the T6 connection (or interface) 106. A detailed view of the CN DP 122 is depicted in FIG. 2 according to an aspect, and detail views of the RAN DP 112 are depicted in FIGS. 3 and 4, according to an aspect.

FIG. 2 illustrates a CN data plane architecture, according to an aspect. The CN DP 122 may include a connection sub plane 210 and a processing sub plane 220. The connection sub plane 210 may include one or multiple connection sub plane functions (NPFs) 212. The processing sub plane 220 may include one or multiple processing functions (PFs) 222. The NPF(s) 212 and the PF(s) 222 are DPFs.

In some aspects, the NPF 212 can be viewed as a gateway of the CN DP 122 and can be referred to as CN DP GW. In some aspects, the NPF 212 can connect with the RAN DP via a T3 connection (or interface) 203. In some aspects, the NPF 212 can connect with another NPF in the CN DP via a T4 connection (or interface) 204. In some aspects, the NPF 212 can connect with a PF in the CN DP via a T5 connection (or interface) 205. In some aspects, the NPF 212 can connect with the DN 130 via a T6 connection (or interface) 206 as illustrated. The T3 connection 203, the T6 connection 206 and the air interface 201 in FIG. 2 respectively correspond to the T3 connection 103, the T6 connection 106 and the air interface 101 in FIG. 1.

In some aspects, each of the T3 connection 203, the T4 connection 304 and the T5 connection 206 may be implemented or supported by a tunnel (referred to as a CN tunnel). The CN tunnel may be a layer 4 (L4) tunnel, and the tunneling protocol(s) for the CN tunnel may be any of QUIC, QUIC/UDP, and GTP-U/UDP. In some aspects, the CN tunnel may be supported by IPv4 routing or IPv6 routing at the layer 3 (L3, IP layer). In some aspects, the T6 connection 206 may also be implemented by a tunnel. Similar to the CN tunnel, the tunnel corresponding to the T6 connection may also be an L4 tunnel, and the tunneling protocol(s) for the tunnel corresponding to the T6 connection may be the same as that (those) of the CN tunnel (e.g., any of QUIC, QUIC/UDP, and GTP-U/UDP). The tunnel corresponding to the T6 connection may be supported by IPv4 routing or IPv6 routing at the layer 3 (L3, IP layer).

A T3 tunnel, a T4 tunnel, a T5 tunnel or a T6 tunnel refers to a tunnel that implements or supports a T3 connection, a T4 connection, a T5 connection or a T6 connection respectively. Thus, in this application, the terms T3 tunnel and T3 connection are equivalent, and the terms T4 tunnel and T4 connection are equivalent, and the terms T5 tunnel and T5 connection are equivalent, and the terms T6 tunnel and T6 connection are equivalent.

FIG. 3 illustrates a RAN data plane architecture, according to an aspect. The RAN DP 300 (which may be similar to RAN DP 112) may include a connection sub plane 310 and a processing sub plane 320. The connection sub plane 310 may include one or more of: a distributed unit (DU) 312 (i.e. one or multiple DUs), a centralized unit (CU) 314 (i.e. one or multiple CUs), and a processing unit (PU) 316 (i.e. one or multiple PUs). In some aspects, the DU 312 may include a transmission and reception point (TRP) (i.e. one or multiple TRPs). The TRP may be equipped with one or multiple antennas or antenna arrays and may transmit and receive radio signals. In some aspects, the TRP may be decoupled (separate) from the DU. To be differentiated from a CU in the RAN CP described herein, the centralized unit (CU) in the RAN DP may be referred to as CU-DP 314.

In some aspects, the processing sub plane 320 may include one or more PU back-end 322. The PU back-end (PU-BE) 322 may be communicatively coupled with, i.e., connected to, the PU 316 via an M5 connection (or interface) 305. The PU-BE 322 may also be communicatively coupled with other PU(s) in the RAN DP through different M5 connection(s).

In some aspects, PU (e.g., PU 316) is a type of DP GW, while PU-BE 322 is similar to a PF. In some aspects, a processing function in the CN may be denoted as PF, and a processing function in the RAN may be denoted as a PU-BE. A PF in the CN connects to an NPF (which is a CN DP GW). A PU-BE in the RAN connects to a PU (which is a RAN DP GW).

In some aspects, each of the CU-DP 314 and the PU 316 can be viewed as a gateway of the RAN DP 300 and can be referred to as a RAN DP GW. In some aspects, the CU-DP 314 may have a T3 connection (or interface) 303 with the CN 120 (e.g., CN DP 122), which connects the CU-DP 314 with an NPF 212 in the CN DP 122.

In some aspects, the PU 316 may have a T3 connection 303 with the CN DP 122 as illustrated in FIG. 3. In some aspects the PU (e.g., PU 416) may not have a T3 connection with the CN DP 122 as illustrated in FIG. 4. FIG. 4 illustrates another RAN data plane architecture, according to an aspect.

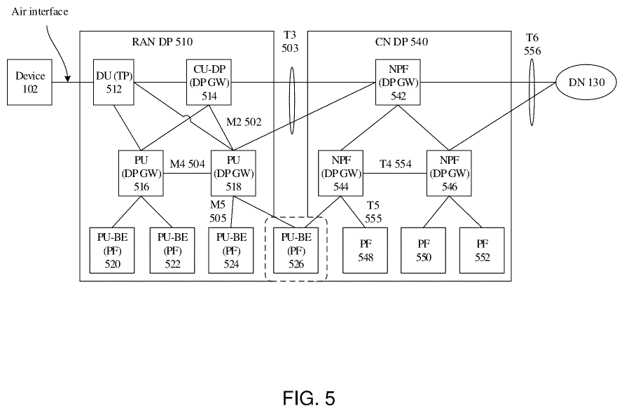

The RAN DP 400 may be similar to the RAN DP 300; however, the PU 416 may have an M2 connection 402 with the CU-DP 414, without having a T3 connection with the CN 120. Whereas the PU 316 may have a T3 connection 303 with the CN 120, without having an M2 connection with the CU-DP 314. In some aspects, a PU 518 within a RAN DP may have one or both of an M2 connection and a T3 connection, as shown in FIG. 5.

Similar to the RAN DP 300, RAN DP 400 (which may be similar to RAN DP 112) may include a connection sub plane 410 (similar to connection sub plan 310) and a processing sub plane 420 (similar to processing sub plane 320). The connection sub plane 410 may include one or more of: a DU 412 (similar to DU 312), a CU 414 (similar to CU 314), and a PU 416 (similar to PU 316). In some aspects, the processing sub plane 420 may include one or more PU-BE 422 (similar to PU-BE 322). The PU-BE 422 may be communicatively coupled with, i.e., connected to, the PU 416 via an M5 connection (or interface) 405 (similar to M5 305). The PU-BE 422 may also be communicatively coupled with other PU(s) in the RAN DP through different M5 connection(s).

In some aspects, an M2 connection (e.g. M2 connection 402) or an M5 connection (e.g. M5 connection 305 or 405) as described above may be implemented or supported by a tunnel (referred to as a RAN tunnel). The RAN tunnel may be a layer 4 (L4) tunnel, and the tunneling protocol(s) for the RAN tunnel may be any of QUIC, QUIC/UDP, and GTP-U/UDP. In some aspects, the RAN tunnel may be supported by IPv4 routing or IPv6 routing at the layer 3 (L3, IP layer).

An M2 tunnel or an M5 tunnel refers to a tunnel that implements or supports an M2 connection or an M5 connection. Thus, in this application, the terms M2 tunnel and M2 connection are equivalent, and the terms M5 tunnel and M5 connection are equivalent.

In some aspects, the T3 connection 303 in FIGS. 3 and T3 connection 403 in FIG. 4 may correspond with the T3 connection 203 in FIG. 2 and the T3 connection 103 in FIG. 1. Each of the T3 connections may be implemented or supported by a tunnel. Thus, the terms T3 connection and T3 tunnel, as used herein, may be equivalent.

In some aspects, referring to FIG. 3, the PU 316 may have a T3 connection 303 that connects the PU 316 with an NPF 212 in the CN DP 122, and the PU 316 can use the T3 connection 303 to interact or communicate with the NPF 212, i.e., send data traffic to and receive data traffic from the NPF 212. In some aspects, referring to FIG. 4, the PU 416 may not have such a T3 connection with an NPF 212 and may interact or communicate with an NPF 212 in the CN DP 122 via the CU-DP 414, i.e., send data traffic to and receive data traffic from the NPF 212 via the CU-DP 414. As shown in FIG. 4, the PU 416 may connect with the CU-DP 414 via an M2 connection (or interface) 402. In some aspects, when the PU 416 interacts or communicates with the NPF 212 via the CU-DP 414, the data traffic may be transported between the PU 416 and the NPF 212 through the T3 connection 403 (between the CU-DP 414 and the NPF 212) and the M2 connection 402 (between the PU 416 and the CU-DP 414).

In some aspects, the RAN 110 may include one or multiple RAN nodes. Each RAN node may include a CU-CP, a CU-DP (e.g., CU-DP 314 or 414) and one or more PUs (e.g., PU 316 or 416). In some aspects, when there are multiple CU-DP(s) or PU(s) in the RAN DP, the multiple CU-DPs or PUs may belong to different RAN nodes in the RAN 110. In some aspects, when a PU-BE (e.g., PU-BE 322 or PU-BE 422) is communicatively coupled with multiple PUS that belong to different RAN nodes, the PU-BE may be shared by the different RAN nodes. Likewise, when there are multiple DUs (e.g. DU 312 or 412) in the RAN DP, the multiple DUs may belong to different RAN nodes.

In some aspects, when there are multiple CU-CPs in the RAN CP, the multiple CU-CPs may belong to different RAN nodes. In general, a CU-CP of a RAN node can manage or control one or more of: DUs, CU-DP(s) and PU(s) of the RAN node. In some aspects, a CU-CP may belong to (i.e., shared by) multiple RAN nodes, and the CU-CP can manage or control DUS, CU-DP(s) and PU(s) of all these multiple RAN nodes.

As may be appreciated by a person skilled in the art, a CU-CP, a CU-DP, a PU or a PU-BE as described herein may be a logical network entity. Any two, three or all of them may be combined or integrated into a single network entity. As each of CU-DP, the PU and the PU-BE is part of the RAN DP, each may be a DPF.

A device 102 can connect to the RAN DP 300 or 400 through an air interface 301 or 401 respectively. As illustrated in FIG. 3 and FIG. 4, the air interface 301 or 401 may be between the device 102 and the distributed unit (DU) 312 or 412 in the RAN DP 300 or 400. In some aspects, when the device 301 accesses a connectivity service offered or provided by the communication system (e.g., a data connectivity service provided by a PDU session in the 5G system), the device may be allocated with a data radio bearer (DRB) 307 or 407 over the air interface. In some aspects, when the device 102 accesses a processing service offered or provided by the communication system, the device 102 may be allocated with a processing radio bearer (XRB) 308 or 408 over the air interface. The processing service may be offered or provided at least in part by a PF (e.g., PF 222) in the CN DP 122 or a PU-BE 322 or 422 in the RAN DP 300 or 400. Both the DRB 307 or 407 and the XRB 308 or 408 may be radio bearers.

In some aspects, a radio bearer (e.g., the DRB 307 or 308 or the XRB 407 or 408 described above) may correspond to a layer-2 logical channel or tunnel that connects a device (e.g. the device 102) and a RAN DP (e.g. the RAN DP 300 or 400). The radio protocol stack for a radio bearer (i.e. the corresponding layer-2 logical channel or tunnel) may include a MAC layer, an RLC layer, a PDCP layer and an SDAP layer, for example, as defined in the 5G system. In the RAN DP, the MAC layer and the RLC layer may be located (running) at a DU (e.g. the DU 312 or 412), and the PDCP layer and the SDAP layer may be located (running) in the CU-DP (e.g. the CU-DP 314 or 414) or in a PU (e.g. the PU 316 or 416), depending on whether the radio bearer is a DRB or an XRB. For example, if the radio bearer is a DRB 307 or 407, the PDCP layer and the SDAP layer may be located (running) at the CU-DP 314 or 414. If the radio bearer is an XRB 308 or 408, the PDCP layer and the SDAP layer may be located (running) at the PU 316 or 416.

As illustrated in FIG. 3 and FIG. 4, the DRB 307 or 308 (i.e. the corresponding layer-2 logical channel or tunnel) may connect the device 102 to the CU-DP 314 or 414, while the XRB 308 or 408 (i.e. the corresponding layer-2 logical channel or tunnel) may connect the device 102 to the PU 316 or 416. Compared with the DRB 307 or 407, the XRB 308 or 408 may have simplified protocol behavior at the RLC and PDCP layers. For example, the RLC layer at the XRB 308 or 408 may be in transparent-mode (TM) (i.e., no RLC segmentation, no RLC acknowledgment). In some aspects, the PDCP layer at the XRB 308 and 408 may operate without performing one or more of: PDCP sequencing, and PDCP security). Accordingly, the protocol stack at the XRB 308 or 408 may operate without performing one or more of: PDCP sequencing, PDCP security, RLC segmentation, RLC acknowledgment. In some aspects, an XRB 308 or 408 may be viewed as a special type of DRB.

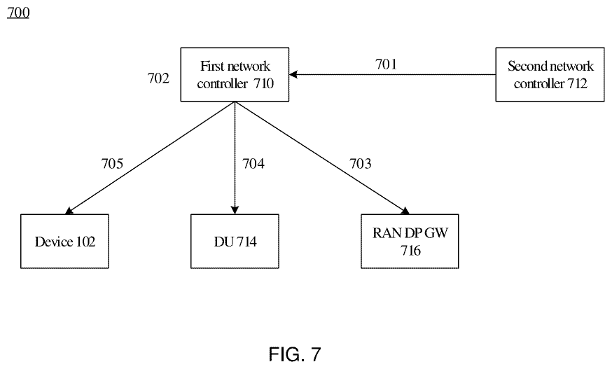

In some aspects, the DRB 307 or 407 may be allocated to the device 102 by a first RAN controller, which may be part of a CU-CP or separate from the CU-CP. In some aspects, the XRB 308 or 408 may be allocated to the device 102 by a second RAN controller, which may be part of a CU-CP or separate from the CU-CP. In some aspects, the first RAN controller and the second RAN controller may be the same entity, e.g., the first network controller described in reference to FIG. 7.

FIG. 5 illustrates an overall data plane architecture, according to an aspect. In an aspect, the overall DP of the communication system may comprise a RAN DP 510 and a CN DP 540. In an aspect, the RAN DP 510 may be similar to RAN DP 112, 300, or 400. In an aspect, the CN DP 540 may be similar to CN DP 122.

In an aspect, the connection sub-plane of the overall DP (i.e., the connection sub-plane of the communication system) may comprise the connection sub-plane of the RAN DP 510 and that of the CN DP 540. In an aspect, the processing sub-plane of the overall DP (i.e., the processing sub plane of the communication system) may comprise the processing sub-plane of the RAN DP 510 and that of the CN DP 540.

In an aspect, the RAN DP 510 of the overall DP architecture may have features of both RAN DP 300 and 400. For example, both RAN DP architecture 300 and 400 may be present in combination in the overall DP architecture. As illustrated, in an aspect, a first PU 518 in the RAN DP 510 may have a T3 connection 503 with the CN DP 540 (i.e., an NPF 542 in the CN DP 540), while a second PU 516 in the RAN DP 510 may not have a T3 connection with the CN DP 540. The first PU 518 may be similar to the PU 316 having a T3 connection 303 with the NPF 212 (in FIG. 3). The second PU 516 may be similar to the PU 416 not having a T3 connection with the NPF 212 (in FIG. 4). In some aspect, in addition to the T3 503 connection, PU 518 may have an M2 502 connection with a CU-DP 514.

In some aspect, a PF 526 in the CN DP 540 can be shared by the RAN DP 510 in the form of a PU-BE 526. Similarly, a PU-BE 526 in the RAN DP 510 can be shared by the CN DP 540 in the form of a PF 526. The sharing is illustrated in FIG. 5 indicated via a dashed box. In some aspects, in the sharing, a network entity (e.g., PF 526) connects, via a T5 connection 555, to an NPF 544 in the CN DP 540 as PF, and the network entity (e.g., PU-BE 526) connects, via an M5 connection 505, to a PU 518 in the RAN DP 510 as PU-BE.

In some aspects, each of the PU-BE(s) and PF(s) may be referred to as a processing service function or a processing sub plane function (PSF), and collectively referred to as PSFs. In some aspects, a PU-BE located in the RAN may be referred to as a RAN PSF, and a PF located in the CN may be referred to as a CN PSF. In some aspects, each of the RAN DP GW(s) (i.e., each of the CU-DP(s), PU(s)) and the CN DP GW(s) (i.e., NPF(s)) may be referred to as a DP GW (and collectively referred to as DP GWs). In some aspects, each of the PSFs and the DP GWs may be referred as a DPF, as described herein.

According to an aspect, a PU entity, as a system component in a RAN node, is provided in the RAN architecture. In some aspects, a RAN controller (e.g., CU-CP) may configure the PU for PDU header processing and PDU content processing. According to the configuration, the PU may perform PDU header processing and PDU content processing.

In some aspects, a RAN controller (e.g., CU-CP) may configure the CU-DP for PDU header processing, and according to the configuration, the CU-DP may perform PDU header processing accordingly.

In some aspects, a RAN controller (e.g., CU-CP) may allocate an XRB for a device and configure the XRB at the device and at a PU, according to information received from a CN controller.

In some aspects, a CN controller (e.g., an SMF in 5G architecture) may configure an NPF (e.g., a UPF in 5G) for PDU header processing and PDU content processing. According to the configuration, the NPF may perform PDU header processing and PDU content processing. In some aspects, a CN controller may send an indication to a RAN controller, according to which the RAN controller may allocate to a device one or more of: a DRB or an XRB.

One or more aspects of the disclosure described herein may be associated with one or more system architectures described in reference to FIGS. 1, 2, 3, 4, and 5.

A PDU associated or related to a connectivity service may be a PDU that the connection service is routing or transporting. In some aspects, a connectivity service can be provided as or in the form of, e.g., a PDU session in 5G.

A PDU originated from a processing service may be a PDU that originated from a PSF as a result of the PSF's offering or providing at least part of the processing service. A PDU targeting a processing service may be a PDU that is to be delivered to a PSF for processing, the processing being part of the PSF's offering or providing at least part of the processing service. A PDU associated or related to a processing service may be originated from or targeting the processing service. In some aspects, a processing service may be associated with an address. The address of the processing service may be used as a source address (e.g., in a PDU originated from the processing service) or a destination address (e.g., in a PDU targeting the processing service) in a data plane traffic, as described in one or more aspects herein.

A network entity may access a processing service offered or provided by the communication system. The network entity may be a device such as UE 102, a server such as an AS in a DN 130, a DPF (a network entity in the DP) such as a DP GW or a PSF. As described herein a DP GW may be a RAN DP GW 314, 316, 414, 416, 514, 516, 518 or a CN DP GW 212, 542, 544, 546. As further described herein a PSF may be RAN PSF 322, 422, 520, 522, 524 and 526 or a CN PSF 222, 526, 548, 550, and 552. When accessing the processing service, the network entity may interact or communicate with a PSF (e.g., which may be a CN PSF 222, 526, 548, 550, and 552 or a RAN PSF 322, 422, 520, 522, 524 and 526) in the processing sub plane of the communication system, the PSF offering or providing at least in part the processing service.

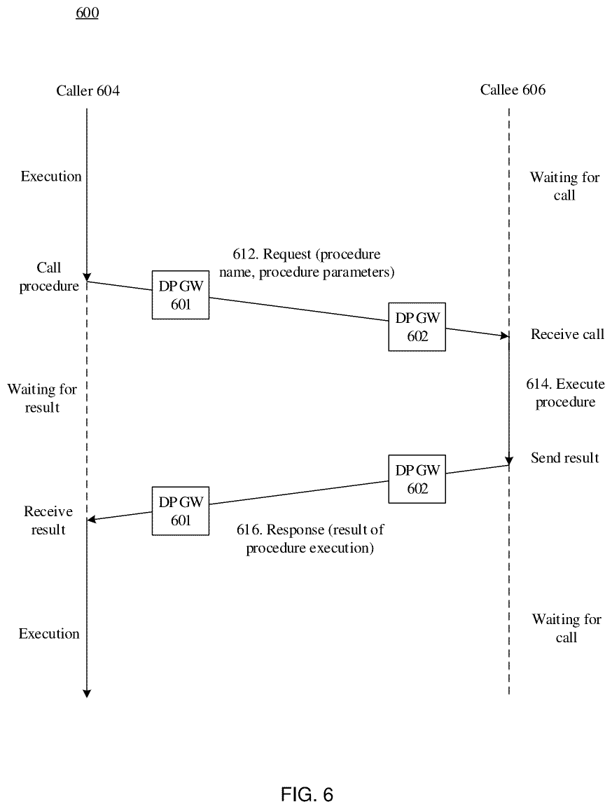

The network entity may be associated with a DP GW in the connection sub-plane (e.g., a RAN DP GW 314, 316, 414, 416, 514, 516, 518 or a CN DP GW 212, 542, 544, 546) of the communication system (e.g., DP GW 601 or DP GW 602 in FIG. 6) and may be connected to the DP GW through a tunnel. In some aspects, the DP GW may be a RAN DP GW (e.g., a PU) if the network entity is a device or a RAN PSF, and a CN DP GW otherwise. In some aspects, the tunnel may be (or correspond to) an XRB if the network entity is a device. In some aspects, the tunnel may correspond to an M5 connection if the network entity is a RAN PSF. In some aspects, the tunnel may correspond to a T5 connection if the network entity is a CN PSF. In some aspects, the tunnel may correspond to a T6 connection if the network entity is an AS (in a DN).

In some aspects, the PSF may be associated with a DP GW (e.g., DP GW 601 or DP GW 602 in FIG. 6) in the connection sub-plane of the communication system and may be connected to the DP GW through a connection. The connection is supported by or implemented as a tunnel between the PSF and the DP GW. In the case that the PSF is a RAN PSF, the DP GW may be a RAN DP GW (e.g., a PU), and the connection is an M5 connection. In the case that the PSF is a CN PSF, the DP GW is an NPF, and the connection is a T5 connection. In some aspects, the DP GW associated with the network entity and the DP GW associated with the PSF may be a same or different network entity.

In some aspects, when the network entity communicates or interacts with the PSF (e.g., using a service based interface (SBI) as described herein including in reference to FIG. 6), data may be exchanged or transported between the network entity and the PSF. The data may include, for example, the request and the response as described in association with FIG. 6. During the exchanging or transporting of the data, the data may be routed through the connection sub plane of the communication system between the network entity and the PSF, for example, through the DP GW associated the network entity and the DP GW associated with the PSF. The data may be routed through a tunnel between the network entity and its associated DP GW and a tunnel between the PSF and its associated DP GW. In some aspects, if the DP GW associated with the network entity and the DP GW associated with the PSF are not a same network entity, the data may further be routed through one or multiple tunnels connecting the two DP GWs.

In some aspects, the interaction or communication between the network entity and the PSF may be based on one or more service based interfaces (SBIs) in the processing sub-plane, above the L4 (i.e., on top of the connection sub-plane of the communication system, through their associated DP GWs). In some aspects, an SBI may be in the form of a remote procedure call (RPC), as illustrated in FIG. 6.

FIG. 6 illustrates a remote procedure call (RPC), according to an aspect. The procedure 600 may be performed at in the processing sub-plane of the communication system.

For example, one of the network entity and the PSF may perform or initiate an RPC and is referred to as caller 604. When performing or initiating the RPC, the caller 604 may remotely call a procedure (or a function or an API) that is supported or implemented by the other one (referred to as callee 606) of the network entity and the PSF and receive one or multiple results of the execution of the procedure from the callee 606.

In an aspect, when calling the procedure (e.g., performing the corresponding RPC), the caller 604 may send a request 612 (e.g., an HTTP (Hypertext Transfer Protocol) request) to the callee 606. The request may include one or more of: information (e.g., name or ID) identifying the procedure and information about input parameter(s) of the procedure, e.g., name(s) or ID(s) and respective value of the input parameter(s). Upon receiving the request 612, the callee 606 may perform or execute 614 the procedure (as identified in the request) according to the request, using the information about the input parameter(s) included in the request. Afterward, the callee 606 may send a response 616 (e.g., HTTP response) to the caller 604. The response 616 may include one or multiple results of the execution of the procedure. For each of the one or multiple results, the response may include a name or ID of the result and a respective result value.

In some aspects, the format of an SBI in the caller's perspective may not be the same as that of the SBI in the callee's perspective. For example, when the SBI is implemented as a PRC as described herein, the information indicating one or more of: the procedure (e.g., names or ID of the procedure) and the input parameters of the procedure (e.g., name(s) or ID(s) of the input parameter(s)), may not be understood or as expected by the callee 606. Similarly, the response including information indicating one or more of: the results (e.g., name(s) or ID(s) of the results) may not be understood or as expected by the caller 604. Hence, in some aspects, an SBI adaptation may be needed so that the caller 604 and the callee 606 can understand each other (i.e., understand the information in the request or the information in the response as described herein).

In some aspects, the DP GW associated with the caller 604 may be denoted as DP GW 601, and the DP GW associated with the callee may be denoted as DP GW 602.

In some aspects, the DP GW 601 and the DP GW 602 may be a same or different network entity. The SBI adaptation may be performed by one or multiple DP GWs, e.g., DP GW 601 and DP GW 602. In an aspect, the caller 604 may perform or initiate an RPC in its own format. As the request 612 associated with the RPC is transported to the callee 606 through one or more DP GWs (e.g., DP GW 601 and DP GW 602), in an aspect, the DP GW may translate, convert or map some or all information (i.e., a first name or ID of the procedure, a first name or ID of an input parameter of the procedure) in the request to information (i.e., a second name or ID of the procedure, a second the name or ID of the input parameter of the procedure) that can be understood by the callee 606. Accordingly, when the callee 606 receives the request 612, the request includes the translated information (i.e., the second name or ID of the procedure, the second the name or ID of the input parameter of the procedure).

After performing the procedure as identified in the request, the callee 606 may send the response 616 in its own format. As the response is transported to the caller 604 through one or more DP GWs (e.g., DP GW 602 and DP GW 601), in an aspect, the DP GW may translate, convert or map the information (i.e., a first name or ID of a result) in the response to information (i.e., a second name or ID of the result) that can be understood by the caller 604. Accordingly, when the caller 604 receives the response 616, the response 616 includes the translated information (i.e., the second name or ID of the result).

As may be appreciated by a person skilled in the art, when performing the SBI adaptation as described herein, the one or more DP GWs (e.g., DP GW 601 and DP GW 602) may process the content of the communication (i.e., the data exchanged or transported) between the caller 604 and the callee 606. The data exchanged or transported between the caller 604 and the callee 606 may include the request 612 and the response 616 as described in association with the FIG. 6. When being transported, the data is carried or included in a data traffic. The data traffic may comprise one or multiple PDUs. Each of these PDUs may include a PDU header and a PDU payload, the PDU header may include information related to the routing and the PDU payload may include at least part of the data.

In an aspect, when the request 612 is being transported through the DP GW 601 and the DP GW 602 from the caller 604 to the callee 606, the request 612 may be included in one PDU, or may be segmented into multiple pieces, each being included in a different PDU (thus resulting in multiple PDUs) at the DP GW 601. The DP GW 601 may then send the one or multiple PDUs to the DP GW 602. In some aspects, the DP GW 601 may be configured to perform the SBI adaptation for the request before the sending of the one or multiple PDUs. In some aspects, when the request 612 is segmented into the multiple PDUs by the DP GW 601, the DP GW 602 may reassemble the multiple PDUs (i.e., data included in the payloads of the multiple PDUs) to obtain the request. In some aspects, the DP GW 602 may be configured to perform the SBI adaptation for the request (i.e., translate information in the request) after the reassembling.

In some aspects, when the response 616 is being transported through the DP GW 602 and the DP GW 601 from the callee 606 to the caller 604, the response 616 may be included in one PDU, or may be segmented into multiple pieces, each being included in a different PDU (thus resulting in multiple PDUs) at the DP GW 602. The DP GW 602 may then send the one or multiple PDUs to the DP GW 601. In some aspects, the DP GW 602 may be configured to perform the SBI adaptation for the response before the sending of the one or multiple PDUs. In some aspects, when the response 616 may be segmented into the multiple PDUs by the DP GW 602, the DP GW 601 may reassemble the multiple PDUs to obtain the response 616. In some aspects, the DP GW 601 may be configured to perform the SBI adaptation for the response 616 (i.e., translate information in the response) after the reassembling.

The connection sub-plane of the communication system may include one or multiple DP GWs, as illustrated in FIG. 5, for example. When a PDU is being routed through the connection sub-plane, a DP GW may handle the PDU, including receiving, processing, and re-transmitting the PDU. The PDU may be related to a network entity, e.g., the network entity described in association with FIG. 6. The PDU may be originated from the network entity or, may be targeting the network entity (that is, the network entity is a destination of the PDU). For example, the PDU may be part of the data traffic that carries the data exchanged between the caller 604 and the callee 606 in FIG. 6, and the DP GW may be the DP GW 601 or 602 in FIG. 6.

In some aspects, when processing the PDU, the DP GW may process the PDU header of the PDU, and the processing of the header may cause the content or information in the PDU header being updated or modified. According to an aspect, how the DP GW may process the PDU header of the PDU is described, i.e., behavior of the DP GW related to processing the PDU header.

According to one or more aspects, the behavior of the DP GW is described when the DP GW is a RAN DP GW (i.e., RAN DP GW behavior), the DP GW being, for example, a RAN DP GW described in association with FIGS. 3, 4, 5, and when the DP GW is a CN DP GW (i.e., CN DP GW behavior), the CN GW being, for example, a CN DP GW described in association with FIGS. 2, 5.

According to an aspect, RAN DP GW behavior is described when the PDU is received from a tunnel other than a radio bearer (e.g., the PDU is not received from a radio bearer). For example, the RAN DP GW may receive the PDU from a tunnel that is not a radio bearer (e.g., a DRB or an XRB). In an aspect, the PDU may be originated from a network entity, which may be a PSF, an AS (in a DN), or a device (e.g., UE). The network entity may be referred to as an originator. The tunnel may be referred to as a receiving tunnel. The receiving tunnel may have two end points. The end point that receives the PDU is called the receiver end, and the end point that sends the PDU is called the sender end. The receiver end of the receiving tunnel is the RAN DP GW, the sender end may or may not be within the RAN as described herein.

The receiving tunnel may be (1) a T3 tunnel, wherein the sender end is a CN DP GW. In some aspects, the receiving tunnel may be (2) an M4 tunnel, wherein the sender end is a second RAN DP GW. In some aspects, the receiving tunnel may be (3) an M5 tunnel, wherein the sender end is a RAN PSF. In some aspects, the receiving tunnel may be (4) an M2 tunnel, wherein the sender end is a third RAN DP GW.

The RAN DP GW may be a CU-DP or a PU when the receiving tunnel is a T3 tunnel (e.g., the sender end is a CN DP GW) or when the receiving tunnel is an M2 tunnel (e.g., the sender end is a third RAN DP GW. The RAN DP GW may be a PU when the receiving tunnel is an M4 tunnel (e.g., the send end is a second RAN DP GW) or when the receiving tunnel is an M5 tunnel (e.g., the sender end is a RAN PSF). Accordingly, the RAN DP GW may be a CU-DP or a PU in the cases (1) and (4), and a PU in the cases (2) and (3).

The originator may be an AS or a PSF in the case (1), a RAN PSF communicatively coupled with the second RAN DP GW in the case (2), the RAN PSF in the case (3), and an AS or a PSF in the case (4). A person skilled in the art may appreciate that in the case (3) the sender end of the receiving tunnel is the originator.

In some aspects, the PDU header of the PDU includes a first L3 header and a first L4 header. The first L3 header may include one or more of: a source address, referred to as SRC1, and a destination address, referred to as DST1. The first L3 header may further include a Qos information, referred to as QoS1. The QoS1 may identify a class or priority of the PDU or a Qos flow that the PDU belongs to.

In some aspects, the SRC1 is an address of the sender end. If the sender end belongs to a RAN node (e.g., when the sender end is a RAN DP GW belonging to that RAN node), the address of the sender end may be an address of that RAN node. In some aspects, the SRC1 is an address of the originator. In some embodiments, when the PDU is originated from a processing service, the SRC1 may be an address of the processing service.

In some aspects, the DST1 is be an address of the RAN DP GW. If the RAN DP GW belongs to a RAN node, the address of the RAN DP GW may be an address of the RAN node. In some aspects, when the PDU is targeting a processing service, the DST1 may be an address of the processing service.

The first L4 header may include a connection ID, referred to as CON1. In some aspects, the CON1 may identify the receiving tunnel. In some aspects, when the receiving tunnel is associated with a processing service or when the PDU is associated to a processing service, the CON1 identifies or corresponds to a connection between the originator of the PDU and the final destination of the PDU. In some aspects, when the receiving tunnel is associated with a connectivity service or when the PDU is associated to a connectivity service, wherein the connectivity service connects two network entities (e.g., a device and an AS in a DN), the CON1 identifies or corresponds to a connection between the two network entities. The first L4 header may further include a stream ID, referred to as STR1. In some aspects, the STR1 may identify a stream of traffic, the stream of traffic being associated with the connection identified by the CON1.

In some aspects, after receiving the PDU, the RAN DP GW may identify another tunnel, referred to as transmitting tunnel. The RAN DP GW may transmit or send the PDU using the transmitting tunnel. In some aspects, the receiving tunnel is mapped to the transmitting tunnel, and the RAN DP GW identifies the transmitting tunnel according to the mapping.

In some aspects, the RAN DP GW may identify the transmitting tunnel using information in the PDU header of the PDU. In some aspects, the CON1 (i.e., the connection ID in the first L4 header) corresponds or maps to another connection ID, CON2, which identifies the transmitting tunnel, and according to the mapping, the RAN DP GW identifies the transmitting tunnel.

In some aspects, the CON1 and the QoS1 (i.e., the QoS information in the first L3 header) together correspond or map to the CON2, and according to the mapping, the RAN DP GW identifies the transmitting tunnel.

In some aspects, the mapping that the RAN DP GW uses to identify the transmitting tunnel as described herein may be provided to the RAN DP GW from a network controller, e.g., the first network controller in FIG. 7.

In an aspect, the transmitting tunnel has two end points. The end point that receives the PDU is called the receiver end, and the end point that sends the PDU is called the sender end. The sender end is the RAN DP GW. The receiver end may or may not be within the RAN as described in one or more aspects herein.

In an aspect, the RAN DP GW is a CU-DP (e.g., CU-DP 414 or 514). As an example, when the PDU is related or associated to a processing service and when the receiving tunnel is a T3 tunnel (e.g., T3 403 or 503), the transmitting tunnel may be an M2 tunnel (e.g., M2 402 or 502), wherein the receiver end is another RAN DP GW (which is a PU, e.g., PU 416 or 518). When the RAN DP GW transmits or sends the PDU using the transmitting tunnel, the PDU is delivered to the other RAN DP GW.

In an aspect, the RAN DP GW is a CU-DP (e.g., CU-DP 414, or 514). As an example, when the PDU is related or associated to a processing service and when the receiving tunnel is an M2 tunnel, e.g., M2 402 or 502, the transmitting tunnel may be a T3 tunnel (e.g., T3 403 or 503), wherein the receiver end of the transmitting tunnel is a CN DP GW (e.g., NPF 212 or 542). When the RAN DP GW transmits or sends the PDU using the transmitting tunnel, the PDU is delivered to the CN DP GW (e.g., NPF 212 or 542).

In an aspect, the RAN DP GW is a CU-DP (e.g., CU-DP 314 or 414). As an example, when the PDU is related or associated to a connectivity service (and in this case, the receiving tunnel is a T3 tunnel (e.g., 303 or 403)), the transmitting tunnel may be a DRB associated with a device (e.g., DRB 307 or 407), wherein the receiver end is the device (e.g., device 102). When the RAN DP GW transmits or sends the PDU using the transmitting tunnel, the PDU is delivered to the device. The device may be the final destination of the PDU.

In an aspect, the RAN DP GW is a PU and the PDU is related or associated to a processing service. As an example, the transmitting tunnel is an M4 tunnel (e.g., M4 304, 404, or 504), wherein the receiver end is another RAN DP GW (which is also a PU). When the RAN DP GW transmits or sends the PDU using the transmitting tunnel, the PDU is delivered to the other RAN DP GW. The receiving tunnel may be a T3 tunnel (e.g., T3 303, 304 or 503), an M2 (e.g., M2 402 or 502) or an M5 tunnel (e.g., M5 305, 405, or 505).

In an aspect, the RAN DP GW is a PU and the PDU is related or associated to a processing service. As an example, the transmitting tunnel may be an XRB associated with a device (e.g., XRB 308 or 408), wherein the receiver end is the device 102. When the RAN DP GW transmits or sends the PDU using the transmitting tunnel, the PDU is delivered to the device. The device may be the final destination of the PDU. The receiving tunnel may be a T3 tunnel (e.g., T3 303 or 503), an M2 tunnel (e.g., M2 402 or 502), an M4 tunnel (e.g., M4 304, 404 OR 504), or an M5 tunnel (e.g., M4 304, 404, or 504).

In an aspect, the RAN DP GW is a PU and the PDU is related or associated to a processing service. As an example, the transmitting tunnel may be an M5 tunnel (e.g., M5 305, 405, or 505), wherein the receiver end is a RAN PSF (e.g., PUE-BE 322, 422, or 524). When the RAN DP GW transmits or sends the PDU using the transmitting tunnel, the PDU is delivered to the RAN PSF. The RAN PSF may be the final destination of the PDU. The receiving tunnel may be a T3 tunnel (e.g., 303 or 503), an M2 tunnel (e.g., M2 402 or 502), or an M4 tunnel (e.g., M4 304, 404 or 504).

In some aspects, before transmitting or sending the PDU using the transmitting tunnel, the RAN DP GW may process the PDU header of the PDU.

When processing the PDU header, the RAN DP GW may perform L3 proxying. In some embodiments, when performing L3 proxying, the RAN DP GW replaces the first L3 header with a second L3 header (e.g., removes the first L3 header from the PDU header and adds a second L3 header into the PDU header). In some aspects, when performing L3 proxying, the RAN DP GW modifies or changes the first L3 header into the second L3 header.

In some aspects, the second L3 header includes a source address (referred to as SRC2). In some aspects, the SRC2 may be the same as the SRC1 (i.e., the source address in the first L3 header). In some aspects, the SRC2 may be different from the SRC1. In some aspects, the SRC2 is an address of the RAN DP GW. In some aspects, when the PDU is originated from a processing service, the SRC2 is an address of the processing service.

In some aspects, the second L3 header may further include a destination address (referred to as DST2). In some embodiments, the DST2 may be the same as the DST1 (i.e., the destination address in the first L3 header). In some aspects, the DST2 is different from the DST1. In some aspects, the DST2 is an address of the receiver end of the transmitting tunnel. In some embodiments, when the PDU is targeting a processing service, the DST2 is an address of the processing service. In some embodiments, when the transmitting tunnel is a radio bearer (e.g., a DRB or an XRB) associated with a device, the DST2 is an address of the device, and the device may be the final destination of the PDU.

In some aspects, the second L3 header may further includes a QoS information (referred to as QoS2). The QoS2 may identify a class or priority of the PDU or a QoS flow that the PDU belongs to. In some aspects, the QoS2 is the same as the QoS1 (i.e., the QoS information in the first L3 header). In some aspects, the QoS2 is different from the QoS1. When the QoS2 and the QoS1 are different, the difference may cause the PDU to move between different classes, priorities or QoS flows and enable or allow the PDU to be treated differently at different locations in the network, e.g., due to different network conditions (e.g., delay, delay jitter, throughput, bandwidth, congestion) at those different locations. The difference in QoS information may further enable or allow the PDU to be treated differently at different locations in the network to ensure end-to-end QoS performance of the PDU and to balance QoS performance of different PDUs.

In some aspects, when processing PDU header, the RAN DP GW further performs L4 proxying. In some aspects, when performing L4 proxying, the RAN DP GW replaces the first L4 header with a second L4 header (e.g., removes the first L4 header from the PDU header and adds the second L4 header into the PDU header). In some aspects, when performing L4 proxying, the RAN DP GW modifies or changes the first L4 header into the second L4 header. In some aspects, when the transmitting tunnel is not a DRB or an XRB, the second L4 header is the tunnel header of the transmitting tunnel.

In some aspects, the second L4 header may include a connection ID. The connection ID in the second L4 header may be different from the connection ID (CON1) in the first L4 header. The connection ID in the second L4 header may identify the transmitting tunnel. In some aspects, the connection ID in the second L4 header is the CON2 (which identifies the transmitting tunnel) described herein.

In some aspects, when the transmitting tunnel is associated to a processing service or when the PDU is associated to a processing service, the CON2 identifies or corresponds to a connection between the originator of the PDU and the final destination of the PDU. In some aspects, when the transmitting tunnel is associated to a connectivity service or when the PDU is associated to a connectivity service, wherein the connectivity service connects two network entities (e.g., a device and an AS in a DN), the CON2 identifies or corresponds to a connection between the two network entities.

In some aspects, the second L4 header may further include a stream ID, referred to as STR2. In some aspects, the STR2 may identify a stream of traffic, the stream of traffic being associated with the connection identified by the CON2. In some aspects, the STR2 is the same as the STR1 (i.e. the stream ID in the first L4 header). In some aspects, the STR2 is different from the STR1 and is mapped from the STR1. In some aspects, the mapping from the STR1 to the STR2 is provided to the RAN DP GW from a network controller, e.g., the first network controller or the second network controller in FIG. 7. In some aspect, the stream of traffic identified by the STR2 is the stream of traffic identified by the STR1.

According to an aspect, RAN DP GW behavior is described when the PDU is received from a radio bearer.

The RAN DP GW may receive the PDU from a radio bearer, e.g., a DRB 307 or 407 or an XRB 308 or 408, which is associated with a device 102. The radio bearer may correspond to, or be considered as a logical tunnel between the device and the RAN DP GW. In some aspects, the PDU may be considered to have originated from the device, and the device may be referred to as the originator. The radio bearer may be referred to as receiving tunnel. In an aspect, the receiving tunnel has two end points. The end point that receives the PDU is called the receiver end, and the end point that sends the PDU is called the sender end. The sender end is the originator (i.e., the device), and the receiver end is the RAN DP GW.

In some aspects, the receiving tunnel may be (1) a DRB (e.g., DRB 307 or 407) if the RAN DP GW is a CU-DP (e.g., CU-DP 314 or 414). In some aspects, the receiving tunnel may be (2) an XRB (e.g., XRB 308 or 408) if the RAN DP GW is a PU (e.g., PU 316 or 416). The PDU may be related to a connectivity service in the case (1), wherein the receiving tunnel is a DRB, and a processing service in the case (2), wherein the receiving tunnel is an XRB.

In an aspect, the PDU header of the PDU includes a first L3 header and a first L4 header. The first L3 header may include one or more of: a source address, referred to as SRC1, and a destination address, referred to as DST1. The first L3 header may further include a Qos information, referred to as QoS1. The QoS1 may identify a class or priority of the PDU or a Qos flow that the PDU belongs to.

In some aspects, the SRC1 is an address of the sender end, the device (i.e., the originator). In some aspects, when the receiving tunnel is associated to a processing service (e.g., when the receiving tunnel is an XRB that the device uses to access the processing service) or when the PDU is targeting a processing service, the DST1 may an address of the processing service or an address of a PSF that offers or provides at least part of the processing service. In some aspects, the DST1 may be an address of the RAN DP GW. If the RAN DP GW belongs to a RAN node, the address of the RAN DP GW may be an address of the RAN node.

The first L4 header may include a connection ID, referred to as CON1. In some aspects, when the receiving tunnel is associated to a processing service (e.g., when the receiving tunnel is an XRB that the device uses to access the processing service) or when the PDU is associated to a processing service, the CON1 identifies or corresponds to a connection between the device and the processing service (e.g., a PSF that offers or provides at least part of the processing service). In some aspects, when the receiving tunnel is associated to a connectivity service (e.g. when the receiving tunnel is a DRB that the device uses to access the connectivity service) or when the PDU is associated to a connectivity service, wherein the connectivity service connects the device and a DN (e.g., an AS in the DN), the CON1 identifies or corresponds to a connection between the device and the DN (i.e., the AS). The first L4 header may further include a stream ID, referred to as STR1. In some aspects, the STR1 may identify a stream of traffic, the stream of traffic being associated with the connection identified by the CON1.

In some aspects, after receiving the PDU, the RAN DP GW identifies another tunnel, referred to as transmitting tunnel and transmits or sends the PDU using the transmitting tunnel.

In some aspects, the receiving tunnel is mapped to the transmitting tunnel, and the RAN DP GW, according to the mapping, may identify the transmitting tunnel. In some aspects, the RAN DP GW may identify the transmitting tunnel using information in the PDU header of the PDU. In some aspects, the CON1 (i.e., the connection ID in the first L4 header) corresponds or maps to another connection ID, CON2, which identifies the transmitting tunnel, and, according to the mapping, the RAN DP GW identifies the transmitting tunnel. In some aspects, the CON1 and the QoS1 (i.e., the QOS information in the first L3 header) together correspond or map to the CON2, and, according to the mapping, the RAN DP GW identifies the transmitting tunnel. In some aspects, the mapping that the RAN DP GW uses to identify the transmitting tunnel as described herein is provided to the RAN DP GW from a network controller, e.g., the first network controller in FIG. 7.

The transmitting tunnel may have two end points. The end point that receives the PDU is called the receiver end, and the end point that sends the PDU is called the sender end. The sender end is the RAN DP GW, and the receiver end may or may not be within the RAN as described herein.

In an aspect, the RAN DP GW may be a CU-DP (e.g., CU-DP 314, 414, or 514). The PDU may be related or associated to a connectivity service, and the transmitting tunnel may be a T3 tunnel (e.g., T3 303, 403, or 503), wherein the receiver end is an CN DP GW (e.g., NPF 212 or 542) in the CN DP. When the RAN DP GW transmits or sends the PDU using the transmitting tunnel, the PDU is delivered to the CN DP GW.

In an aspect, the RAN DP GW is a PU (e.g., PU 316, 416, 516 or 518). The PDU may be related or associated to a processing service, and the transmitting tunnel may be an M2 tunnel (e.g., M2 402 or 504), an M4 tunnel (e.g., 304, 404, 504), or an M5 tunnel (M5 305, 405 or 505).

In an aspect, the RAN DP GW is a PU (e.g., PU 316 or 518). As an example, the transmitting tunnel is a T3 tunnel (e.g., 303 or 503) wherein the receiver end is a CN DP GW (e.g., NPF 212 or 542). When the RAN DP GW transmits or sends the PDU using the transmitting tunnel, the PDU is delivered to the CN DP GW.

In an aspect, the RAN DP GW is a PU (e.g., PU 416 or 518). As an example, the transmitting tunnel is an M2 tunnel (M2 414 or 502), wherein the receiver end is a CU-DP (e.g., CU-DP 414 or 514). When the RAN DP GW transmits or sends the PDU using the transmitting tunnel, the PDU is delivered to the CU-DP.

In an aspect, the RAN DP GW is a PU (e.g., PU 316, 416, 516 or 518). As an example, the transmitting tunnel is an M4 tunnel (e.g., M4 304, 404 or 504), wherein the receiver end is another PU. The other PU may be communicatively coupled with a RAN PSF that provides or offers at least in part the processing service, and the RAN PSF may be final destination of the PDU. When the RAN DP GW transmits or sends the PDU using the transmitting tunnel, the PDU is delivered to the other PU.

In an aspect, the RAN DP GW is a PU (e.g., PU 316, 416, 516 or 518). As an example, the transmitting tunnel is an M5 tunnel (e.g., M5 305, 405 or 505), wherein the receiver end is a RAN PSF (e.g., PU-BE 322, 422 or 524). The RAN PSF may provide or offer at least in part the processing service. When the RAN DP GW transmits or sends the PDU using the transmitting tunnel, the PDU is delivered to the RAN PSF. The RAN PSF may be the final destination of the PDU.

In an aspect, before transmitting or sending the PDU using the transmitting tunnel, the RAN DP GW may process the PDU header of the PDU.

When processing the PDU header, the RAN DP GW may perform L3 proxying. In some aspects, when performing L3 proxying, the RAN DP GW replaces the first L3 header with a second L3 header (e.g., removes the first L3 header from the PDU header and adds a second L3 header into the PDU header). In some aspects, when performing L3 proxying, the RAN DP GW modifies or changes the first L3 header into the second L3 header.

In some aspects, the second L3 header includes a source address (referred to as SRC2). In some aspects, the SRC2 is the same as the SRC1 (i.e., the source address in the first L3 header). In some aspects, the SRC2 is different from the SRC1. In some aspects, the SRC2 is an address of the RAN DP GW.

In some aspects, the second L3 header includes a destination address (referred to as DST2). In some aspects, the DST2 is the same as the DST1 (i.e., the destination address in the first L3 header). In some aspects, the DST2 is different from the DST1. In some aspects, the DST2 is an address of the receiver end of the transmitting tunnel. In some aspects, when the PDU is targeting a processing service, the DST2 is an address of an NSF that offers or provides at least part of the processing service.

In some aspects, the second L3 header includes a QoS information (referred to as QoS2). The QoS2 may identify a class or priority of the PDU or a QoS flow that the PDU belongs to. In some aspects, the QoS2 is the same as the QoS1 (i.e., the QoS information in the first L3 header). In some aspects, the QoS2 is different from the QoS1. When the QoS2 and the QoS1 are different, the difference causes the PDU to move between different classes, priorities or Qos flows and enables or allows the PDU to be treated differently in different tunnels, e.g., due to different network conditions (e.g., delay, delay jitter, throughput, bandwidth, congestion) at locations that the different tunnels go through. The difference in QoS information may further enable or allow the PDU to be treated different in different tunnels to ensure end-to-end QoS performance of the PDU and to balance QoS performance of different PDUs.

When processing PDU header, the RAN DP GW may further perform L4 proxying. In some aspects, when performing L4 proxying, the RAN DP GW replaces the first L4 header with a second L4 header (e.g., removes the first L4 header from the PDU header and adds the second L4 header into the PDU header). In some aspects, when performing L4 proxying, the RAN DP GW modifies or changes the first L4 header into the second L4 header. The second L4 header may be the tunnel header of the transmitting tunnel.

The second L4 header may include a connection ID. The connection ID in the second L4 header may be different from the CON1 (i.e., the connection ID in the first L4 header). The connection ID in the second L4 header may identify the transmitting tunnel. In some aspects, the connection ID in the second L4 header is the CON2 (which identifies the transmitting tunnel) described herein.

In some aspects, the second L4 header may further include a stream ID, referred to as STR2. In some aspects, the STR2 may identify a stream of traffic, the stream of traffic being associated with the connection identified by the CON2. In some aspects, the STR2 is the same as the STR1 (i.e. the stream ID in the first L4 header). In some aspects, the STR2 is different from the STR1 and is mapped from the STR1. In some aspects, the mapping from the STR1 to the STR2 is provided to the RAN DP GW from a network controller, e.g., the first network controller or the second network controller in FIG. 7. In some aspect, the stream of traffic identified by the STR2 is the stream of traffic identified by the STR1.

According to one or more aspects, CN DP GW behavior is described.

In an aspect, the CN DP GW may receive a PDU. The PDU may be received from a tunnel, referred to as a receiving tunnel. The receiving tunnel may have two end points. The end point that receives the PDU may be called the receiver end, and the end point that sends the PDU is called the sender end. The receiver end may be the CN DP GW. The sender end may be in the RAN, in the CN, or in a DN as described herein.

In some aspects, the receiving tunnel may be (1) a T3 tunnel, wherein the sender end is in the RAN, e.g., a RAN DP GW. In some aspects, the receiving tunnel may be (2) a T4 tunnel, wherein the sender end is another CN DP GW. In some aspects, the receiving tunnel may be (3) a T5 tunnel, wherein the sender end is a CN PSF. In some aspects, the receiving tunnel may be (4) a T6 tunnel, wherein the sender end is in a DN (e.g., an AS).

In an aspect, the PDU may originate from a network entity, which may be a device, a PSF, an AS (in a DN). The network entity may be referred to as an originator. In some aspects, the originator of the PDU may be a device or a RAN PSF wherein the receiving tunnel is a T3 tunnel and the sender end is in the RAN. In some aspects, the originator of the PDU may be a device, a RAN PSF, a CN PSF or an AS wherein the receiving tunnel is a T4 tunnel and the sender end is another CN DP GW. In some aspects, the originator of the PDU may be a CN PSF wherein the receiving tunnel is a T5 tunnel and the sender end is a CN PSF. In some aspects, the originator of the PDU may be an AS wherein the receiving tunnel is a T6 tunnel and the sender end is in a DN.

Accordingly, the originator of the PDU may be: a device or a RAN PSF in the case (1); a device, a RAN PSF, a CN PSF or an AS in the case (2); a CN PSF in the case (3); or an AS in the case (4). In the case (4), the sender may be the originator. When the originator of the PDU is an AS, the AS is in a first DN. The PDU may target a device, a PSF (a RAN PSF or a CN PSF), or a second DN (e.g., an AS in the second DN).

In an aspect, the PDU header of the PDU includes a first L3 header and a first L4 header. The first L3 header may include one or more of: a source address, referred to as SRC1, and a destination address, referred to as DST1.

In some aspects, the SRC1 may be an address of the sender end. If the sender end belongs to a RAN node (e.g., when the sender end is a RAN DP GW belonging to that RAN node), the address of the sender end may be an address of that RAN node.

In some aspects, the SRC1 may be an address of the originator. In some aspects, the PDU may originate from a processing service (e.g., from a PSF that offers or provides the processing service), wherein the SRC1 may be an address of the processing service.

In some aspects, the DST1 may be an address of the CN DP GW. In some aspects, the PDU may target a processing service (e.g., a PSF that offers or provides the processing service), wherein the DST1 may be an address of the processing service.

The first L3 header may further include a QoS information, referred to as QoS1. The QoS1 may identify a class or priority of the PDU or a QoS flow that the PDU belongs to.

The first L4 header may include a connection ID, referred to as CON1. In some aspects, the CON1 identifies the receiving tunnel. In some aspects, when the receiving tunnel is associated with a processing service or when the PDU is associated with a processing service, the CON1 identifies or corresponds to a connection between the originator of the PDU and the final destination of the PDU. In some aspects, when the receiving tunnel is associated with a connectivity service or when the PDU is associated to a connectivity service, wherein the connectivity service connects two network entities (e.g., a device and an AS in a DN), the CON1 identifies or corresponds to a connection between the two network entities. The first L4 header may further include a stream ID, referred to as STR1. In some aspects, the STR1 may identify a stream of traffic, the stream of traffic being associated with the connection identified by the CON1.

After receiving the PDU, the CN DP GW may identify another tunnel, referred to as transmitting tunnel. The CN DP GW may transmit or send the PDU using the transmitting tunnel. In some aspects, the receiving tunnel is mapped to the transmitting tunnel, and the CN DP GW, according to the mapping, identifies the transmitting tunnel.

In some aspects, the CN DP GW may identify the transmitting tunnel using information in the PDU header of the PDU. In some aspects, the CON1 (i.e., the connection ID in the first L4 header) corresponds or maps to another connection ID, CON2, which identifies the transmitting tunnel, and, according to the mapping, the CN DP GW identifies the transmitting tunnel. In some aspects, the CON1 and the QoS1 (i.e., the QOS information in the first L3 header) together correspond or map to the CON2, and, according to the mapping, the CN DP GW identifies the transmitting tunnel. In some aspects, the mapping that the CN DP GW uses to identify the transmitting tunnel as described above is provided to the CN DP GW from a network controller, e.g., the second network controller in FIG. 7.

The transmitting tunnel may have two end points. The end point that receives the PDU is called the receiver end, and the end point that sends the PDU is called the sender end. The sender end is the CN DP GW, and the receiver end may be in the RAN, in the CN, or in a DN as described herein.

In some aspects, the transmitting tunnel is a T3 tunnel (e.g., T3 303, 403, or 503), wherein the receiver end is a RAN DP GW (e.g., CU-DP 314, 414, 514, or PU 316 or 518) in the RAN DP. When the CN DP GW transmits or sends the PDU using the transmitting tunnel, the PDU is delivered to the RAN DP GW.

In some aspects, the transmitting tunnel is a T4 tunnel (e.g., T4 204 or 554), wherein the receiver end is another CN DP GW. When the CN DP GW transmits or sends the PDU using the transmitting tunnel, the PDU is delivered to the other CN DP GW.

In some aspects, when the PDU is related or associated to (targeting) a processing service, the transmitting tunnel is a T5 tunnel (e.g., T5 205 or 555), wherein the receiver end is a CN PSF (e.g., PF 222 or 548). The CN PSF may provide or offer at least in part the processing service. When the CN DP GW transmits or sends the PDU using the transmitting tunnel, the PDU is delivered to the CN PSF. In some aspects, the CN PSF may be the final destination of the PDU.

In some aspects, the transmitting tunnel is a T6 tunnel (e.g., T6 206 or 556), wherein the receiver end is in a DN 130 (e.g., an AS in the DN). When the CN DP GW transmits or sends the PDU using the transmitting tunnel, the PDU is delivered to the AS. The AS may or may not be the final destination of the PDU.

In some aspects, before transmitting or sending the PDU using the transmitting tunnel, the CN DP GW may process the PDU header of the PDU.

When processing the PDU header, the CN DP GW may perform L3 proxying. In some aspects, when performing L3 proxying, the CN DP GW replaces the first L3 header with a second L3 header (e.g., removes the first L3 header from the PDU header and adds a second L3 header into the PDU header). In some embodiments, when performing L3 proxying, the CN DP GW modifies or changes the first L3 header into the second L3 header.

In some aspects, the second L3 header may include a source address (referred to as SRC2). In some aspects, the SRC2 is the same as the SRC1 (i.e., the source address in the first L3 header). In some aspects, the SRC2 is different from the SRC1. In some aspects, the SRC2 is an address of the CN DP GW. In some aspects, the SRC2 is an address of the originator of the PDU. In some aspects, when the PDU is originated from a processing service (e.g., a PSF that offers or provides the processing service), the SRC2 is an address of the processing service.

In some aspects, the second L3 header may include a destination address (referred to as DST2). In some aspects, the DST2 is the same as the DST1 (i.e., the destination address in the first L3 header). In some aspects, the DST2 is different from the DST1. In some aspects, the DST2 is an address of the receiver end of the transmitting tunnel. In some aspects, when the PDU is targeting a processing service, the DST2 is an address of the processing service or a PSF that offers or provides at least part of the processing service.

The second L3 header may further include a QoS information (referred to as QoS2). The QoS2 may identify a class or priority of the PDU or a QoS flow that the PDU belongs to. In some aspects, the QoS2 is the same as the QoS1 (i.e., the QoS information in the first L3 header). In some aspects, the QoS2 is different from the QoS1. When the QoS2 and the QoS1 are different, the difference may cause the PDU to move between different classes, priorities or QoS flows and enable or allow the PDU to be treated differently in different tunnels, e.g., due to different network conditions (e.g., delay, delay jitter, throughput, bandwidth, congestion) at locations that the different tunnels go through. The difference in QoS information may further enable or allow the PDU to be treated differently in different tunnels to ensure end-to-end Qos performance of the PDU and to balance QoS performance of different PDUs.

In some aspects, when processing PDU header, the CN DP GW may further perform L4 proxying. In some aspects, when performing L4 proxying, the CN DP GW replaces the first L4 header with a second L4 header (e.g., removes the first L4 header from the PDU header and adds the second L4 header into the PDU header). In some aspects, when performing L4 proxying, the CN DP GW modifies or changes the first L4 header into the second L4 header. In some aspects, the second L4 header may be the tunnel header of the transmitting tunnel.

The second L4 header may include a connection ID. The connection ID in the second L4 header may be different from the CON1 (i.e., the connection ID in the first L4 header). The connection ID in the second L4 header may identify the transmitting tunnel. In some aspects, the connection ID in the second L4 header is the CON2 which identifies the transmitting tunnel) described herein.

In some aspects, when the transmitting tunnel is associated with a processing service or when the PDU is associated with a processing service, the CON2 identifies or corresponds to a connection between the originator of the PDU and the final destination of the PDU. In some aspects, when the transmitting tunnel is associated with a connectivity service or when the PDU is associated with a connectivity service, wherein the connectivity service connects two network entities (e.g., a device and an AS in a DN), the CON2 identifies or corresponds to a connection between the two network entities.

In some aspects, the second L4 header may further include a stream ID, referred to as STR2. In some aspects, the STR2 may identify a stream of traffic, the stream of traffic being associated with the connection identified by the CON2. In some aspects, the STR2 is the same as the STR1 (i.e. the stream ID in the first L4 header). In some aspects, the STR2 is different from the STR1 and is mapped from the STR1. In some aspects, the mapping from the STR1 to the STR2 is provided to the CN DP GW from a network controller, e.g., the second network controller in FIG. 7. In some aspect, the stream of traffic identified by the STR2 is the stream of traffic identified by the STR1.

According to one or more aspects, allocation of radio bearer is described. There may be two types of radio bearers in the data plane of the communications system, DRB 307 or 407 and XRB 308 or 408, as described in association with FIG. 3 and FIG. 4

In an aspect, the DRB 307 or 407 may connect a device 102 to a CU-DP 314 or 414 in the RAN, while the XRB 308 or 408 may connect the device 102 to a PU 316 or 416 in the RAN.

FIG. 7 illustrates a procedure of allocating a radio bearer (a DRB or an XRB) for a device, according to an aspect. In an aspect, the first network controller 710 may be located in the RAN. In some aspects, the first network controller 710 may be part of a CU-CP. In some aspects, the first network controller 710 may be a network entity separate from the CU-CP. In some aspects, the CU-CP, the CU-DP and the PU may belong to a same RAN node. In some aspects, the PU and the CU-DP belong to the same RAN node. In some aspects, each of the CU-CP, the CU-DP and the PU belongs to a different RAN node.

In an aspect, the first network controller 710 may allocate a DRB or an XRB for the device according to information received from a second network controller 712. The information may indicate whether the device is accessing a data connectivity service or a processing service. Or, the information may indicate whether a DRB or an XRB is needed for the device. In some aspects, the second network controller 712 may be located in the CN and may be a control plane function (CPF). The second network controller 712 may receive (e.g., from the device or another network entity) information about what service the device 102 is accessing. According to this information, the second network controller 712 may know whether the device is accessing a data connectivity service or a processing service and thus whether a DRB or an XRB is needed for the device. Accordingly, the second network controller may indicate this information (i.e., whether the device is accessing a data connectivity service or a processing service or whether a DRB or an XRB is needed for the device) to the first network controller 710.

According to an aspect, the procedure 700 may include, the first network controller 710 receiving 701 an information from a second network controller 712. The information may indicate whether a DRB or an XRB is needed for the device 102 or indicate whether the device 102 is accessing a connectivity service or a processing service.

The procedure 700 may further include, the first network controller 710 allocating 702 a radio bearer for the device 102, according to the information received from the second network controller 712. The radio bearer may be associated with a DU 714 and a RAN DP GW 716. The first network controller may generate an ID to identify the radio bearer.

In some aspects, if the information received from the second network controller indicates that a DRB is needed for the device or the that the device is accessing a data connectivity service, the first network controller allocates a DRB for the device 102. In some aspects, if the information received from the second network controller indicates that an XRB is needed for the device or that the device is accessing a processing service, the first network controller 710 allocates an XRB for the device 102.

The procedure 700 may further include, the first network controller 710 configuring 703 the RAN DP GW 716 associated with the radio bearer, the radio bearer being allocated 702 by the first network controller. Accordingly, the first network controller 710 may configure 703 the radio bear at the RAN DP GW. In some aspects, the first network controller 710 may provide the ID of the radio bearer (generated when allocating 702 the radio bearer) to the RAN DP GW 716 when configuring 703 the RAN DP GW 716.

In some aspects, the first network controller 710 may configure 703 the RAN DP GW to enable or disable certain functionalities at the PDCP sub layer for the radio bearer. The first network controller 710 may configure 703 the RAN DP GW to enable or disable any one or multiple ones of the following functionalities: PDCP security, PDCP sequencing. The RAN DP GW 716 may then accordingly enable or disable those functionality(es) as configured by the first network controller.

In some aspects, when PDCP security is enabled, the PDCP sub layer at the RAN DP GW may perform security measure (e.g., encryption, decryption) for a PDCP SDU or a PDCP PDU associated with the radio bearer. In some aspects, when PDCP security is disabled, the PDCP sub layer at the RAN DP GW may not perform security measures for a PDCP SDU or a PDCP PDU associated with the radio bearer

In some aspects, when the PDCP sequencing is enabled, the PDCP sub layer at the RAN DP GW may include a sequence number in a PDCP PDU for the radio bearer, or alternatively, the PDCP sub layer at the RAN DP GW may include a PDCP header in a PDCP PDU associated with the radio bearer. When the PDCP sequencing is enabled, the PDCP sub layer at the RAN DP GW may perform retransmission for PDCP PDUs, which are transmitted to the device 102, to ensure reliable transmission of the PDCP PDU. When the PDCP sequencing is enabled, the PDCP sub layer at the RAN DP GW may perform reordering for PDCP PDUs, which are received from the device 102, to ensure ordered delivery of the PDCP PDUs.

In some aspects, when PDCP sequence is disabled, the PDCP sub layer at the RAN DP GW may exclude or not include a sequence number in a PDCP PDU for the radio bearer, or alternatively, the PDCP sub layer at the RAN DP GW may exclude or not include a PDCP header in a PDCP PDU associated with the radio bearer. When the PDCP sequencing is disabled, the PDCP sub layer at the RAN DP GW does not perform retransmission for PDCP PDUs, which are transmitted to the device 102. When the PDCP sequencing is disabled, the PDCP sub layer at the RAN DP GW does not perform reordering for PDCP PDUs, which are received from the device 102.

In the case that the radio bearer is a DRB, the RAN DP GW 716 may be a CU-DP. When configuring 703 the RAN DP GW, the first network controller 710 may configure 703 the RAN DP GW 716 to enable one or more of: PDCP security and PDCP sequencing for the radio bearer.

In the case the radio bearer is an XRB, the RAN DP GW 716 may be a PU. When configuring 703 the RAN DP GW 716, the first network controller 710 may configure 703 the RAN DP GW 716 to disable one or more of: PDCP security and PDCP sequencing for the radio bearer.

In some aspects, the procedure 700 may further include, the first network controller 710 configuring 704 the DU 714 associated with the radio bear, the radio bearer being allocated 702 by the first network controller 710. Accordingly, the first network controller 710 may configure 704 the radio bear at the DU 714. In some aspects, the first network controller 710 may provide the ID of the radio bearer (generated when allocating 702 the radio bearer) to the DU 704 when configuring the DU 714.

In some aspects, the first network controller 710 may configure 704 the DU 714 to enable or disable certain functionalities at the RLC sub layer for the radio bearer. The first network controller 710 may configure 704 the DU 704 to enable or disable any one or multiple ones of the following functionalities: RLC segmentation, RCL acknowledgement. The DU 714 may accordingly enable or disable those functionality(es) as configured by the first network controller 710.

In some aspects, when RLC segmentation is enabled, the RLC sub layer at the DU 714 may segment an RLC SDU associated to the radio bearer. In some aspects, when RLC segmentation is disabled, the RLC sub layer at the DU 714 may not segment an RLC SDU associated to the radio bearer.

In some aspects, when RLC acknowledgement is enabled, the RLC sub layer at the DU 714 may transmit or expect to receive acknowledgment for an RLC PDU associated to the radio bearer. In some aspects, when RLC acknowledgement is disabled, the RLC sub layer at the DU 714 may not transmit or not expect to receive acknowledgment for an RLC PDU associated to the radio bearer.

In the case that the radio bearer is a DRB, when configuring 704 the DU 714, the first network controller 710 may configure 704 the DU 714 to enable one or more of: RLC segmentation and RLC acknowledgement for the radio bearer.

In the case that the radio bearer is an XRB, when configuring 704 the DU 714, the first network controller 710 may configure 704 the DU 714 to disable one or more of: RLC segmentation and RLC acknowledgement for the radio bearer.

Procedure 700 may further include, the first network controller 710 informing 705 the device 102 to configure the radio bearer. In some aspects, the first network controller may configure 705 the radio bear at the device 102. The first network controller 710 may provide the ID of the radio bearer (generated when allocating 702 the radio bearer) to the device 102.

The first network controller 710 may configure 705 the device to enable or disable certain functionalities at the RLC and PDCP sub layers for the radio bearer. In some aspects, the configuration 705 may be similar to or consistent with the configuration 704 at the DU 714 and the configuration 703 at the RAN DP GW 716.

The first network controller 710 may configure 705 the device 102 to enable or disable any one or multiple ones of the following functionalities: RLC segmentation, RCL acknowledgement, PDCP security, PDCP sequencing. The device 102 may accordingly enable or disable one or more functionalities at the corresponding RLC and PDCP sub layers as configured by the first network controller 710.

In some aspects, when RLC segmentation is enabled, the RLC sub layer at the device 102 may segment an RLC SDU associated to the radio bearer. In some aspects, when RLC segmentation is disabled, the RLC sub layer at the device 102 may not segment an RLC SDU associated to the radio bearer.

In some aspects, when RLC acknowledgement is enabled, the RLC sub layer at the device 102 may transmit or expect to receive acknowledgment for an RLC PDU associated to the radio bearer. In some aspects, when RLC acknowledgement is disabled, the RLC sub layer at the device 102 may not transmit or not expect to receive acknowledgment for an RLC PDU associated to the radio bearer.

In some aspects, when PDCP security is enable, the PDCP sub layer at the device 102 may perform security measure (e.g., encryption, decryption) for a PDCP SDU or a PDCP PDU associated to the radio bearer. In some aspects, when PDCP security is disabled, the PDCP sub layer at the device 102 may not perform security measure for a PDCP SDU or a PDCP PDU associated to the radio bearer.

In some aspects, when PDCP sequencing is enabled, the PDCP sub layer at the device 102 may include a sequence number in a PDCP PDU for the radio bearer, or alternatively, the PDCP sub layer at the device 102 may include a PDCP header in a PDCP PDU associated to the radio bearer. When the PDCP sequencing is enabled, the PDCP sub layer at the device 102 may perform retransmission for PDCP PDUs, which are transmitted to the RAN DP GW, to ensure reliable transmission of the PDCP PDU. When the PDCP sequencing is enabled, the PDCP sub layer at the device 102 may perform reordering for PDCP PDUs, which are received from the RAN DP GW, to ensure ordered delivery of the PDCP PDUs.

In some aspects, when PDCP sequencing is disabled, the PDCP sub layer at the device 102 may not include a sequence number in a PDCP PDU for the radio bearer, or alternatively, the PDCP sub layer at the device 102 may exclude or not include a PDCP header in a PDCP PDU associated to the radio bearer. When the PDCP sequencing is disabled, the PDCP sub layer at the device 102 may not perform retransmission for PDCP PDUs, which are transmitted to the RAN DP GW. When the PDCP sequencing is disabled, the PDCP sub layer at the device 102 may not perform reordering for PDCP PDUs, which are received from the RAN DP GW.

In the case that the radio bearer is a DRB, when configuring 705 the device 102, the first network controller 710 may configure 705 the device 102 to enable one or more of: RLC segmentation, RLC acknowledgement, PDCP security, and PDCP sequencing for the radio bearer.

In the case that the radio bearer is an XRB, when configuring 705 the device 102, the first network controller may configure 705 the device 102 to disable one or more of: RLC segmentation, RLC acknowledgement, PDCP security, or PDCP sequencing for the radio bearer.

According to some aspects, one or more PUs and their corresponding functionalities, in the RAN architecture may be provided. The PU may enable the RAN to provide data processing natively. According to some aspects, header processing (i.e., L3 proxying and L4 proxying as described elsewhere in this application) at a DP GW may be provided. Header processing may reduce protocol overhead.

According to some aspects, QoS information may be changed when performing L3 proxying. Change of QoS information may support end-to-end QoS provisioning. According to some aspects, content processing (e.g., SBI adaptation as described elsewhere in this application, in reference to FIG. 6) at a DP GW may be provided. Content processing may support non-standardized SBI in the data plane. According to some aspects, an enhanced radio bearer, e.g., an XRB (as described in reference to FIGS. 3 and 4), and allocation of one or more radio bearers based on information received from the CN (as described in reference to FIG. 7) may be provided. Provision and allocation of radio bearers, including XRB, may simplify radio protocol behavior and reduce protocol overhead.

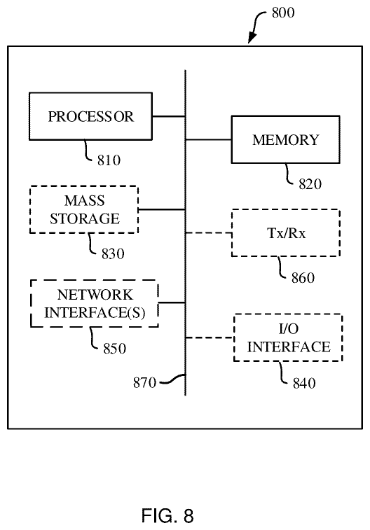

FIG. 8 illustrates an apparatus 800 that may perform any or all of operations of the above methods and features explicitly or implicitly described herein, according to different aspects of the present disclosure. For example, a computer equipped with network function may be configured as the apparatus 800. In some aspects, the apparatus 800 may be a network function, a network node (e.g., a RAN node, a CN node), a device. A RAN node may include any one of: a caller, a caller, a DP GW (e.g., RAN DP GW, CN DP GW), a DU (TP), a CU-DP, a PU, a PU-BE, a PF, an NPF, an a PSF, or any other network node or entity described herein which may be configured to perform one or more operations described herein. In some aspect, apparatus 800 can be a device that connects to the network infrastructure over a radio interface, such as a mobile phone, smart phone or other such device that may be classified as user equipment (UE). In some aspects, the apparatus 800 may be a Machine Type Communications (MTC) device (also referred to as a machine-to-machine (m2m) device), or another such device that may be categorized as a UE despite not providing a direct service to a user. In some aspects, apparatus 800 may be used to implement one or more aspects described herein. For example, the apparatus 800 may be configured to perform operations performed by one or more entities and functions described herein.

As shown, the apparatus 800 may include a processor 810, such as a Central Processing Unit (CPU) or specialized processors such as a Graphics Processing Unit (GPU) or other such processor unit, memory 820, non-transitory mass storage 830, input-output interface 840, network interface 850, and a transceiver 860, all of which are communicatively coupled via bi-directional bus 870. According to certain aspects, any or all of the depicted elements may be utilized, or only a subset of the elements. Further, apparatus 800 may contain multiple instances of certain elements, such as multiple processors, memories, or transceivers. Also, elements of the hardware device may be directly coupled to other elements without the bi-directional bus. Additionally, or alternatively to a processor and memory, other electronics, such as integrated circuits, may be employed for performing the required logical operations.

The memory 820 may include any type of non-transitory memory such as static random-access memory (SRAM), dynamic random-access memory (DRAM), synchronous DRAM (SDRAM), read-only memory (ROM), any combination of such, or the like. The mass storage element 830 may include any type of non-transitory storage device, such as a solid-state drive, hard disk drive, a magnetic disk drive, an optical disk drive, USB drive, or any computer program product configured to store data and machine executable program code. According to certain aspects, the memory 820 or mass storage 830 may have recorded thereon statements and instructions executable by the processor 810 for performing any of the aforementioned method operations described above.

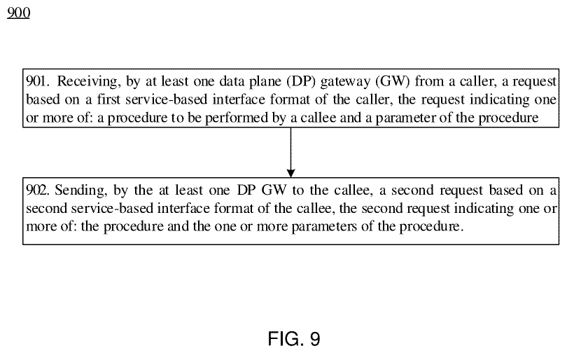

FIG. 9 illustrates a method for processing data at a DP GW, according to an aspect. The DP GW may be RAN DP GW 314, 316, 414, 416, 514, 516, 518 or a CN DP GW 212, 542, 544, 546. The method 900 may include receiving 901, by at least one DP GW from a caller, a request based on a first service-based interface format of the caller. The request may indicate one or more of: a procedure to be performed by a callee and a parameter of the procedure.

The method 900 may further include 902 sending, by the at least one DP GW to the callee, a second request based on a second service-based interface format of the callee, the second request indicating one or more of: the procedure and the one or more parameters of the procedure.

In some aspects, the method may further include mapping, by the at least one DP GW, the request to the second request. In some aspects, receiving, by the at least one DP GW from the caller, the request may include receiving, by the at least one DP GW from the caller, at least one PDU including the request.

In some aspects, mapping, by the at least one DP GW, the request to the second request may include: mapping, by a first DP GW of the at least one DP GW, the request to the second request. In some aspects, sending, by the at least one DP GW to the callee, a second request may include sending, by the first DP GW to a second DP GW of the at least one DP GW, the at least one PDU including the second request.

In some aspects, mapping, by the at least one DP GW, the request to the second request may include sending, by a first DP GW of the at least one DP GW to a second DP GW of the at least one DP GW, the at least one PDU including the request. In some aspects, mapping, by the at least one DP GW, the request to the second request may further include mapping, by the second DP GW, the request to the second request.

In some aspects, sending, by the first DP GW to the second DP GW, the at least one PDU may include segmenting, by the first DP GW, the request into multiple request segments. In some aspects, sending, by the first DP GW to the second DP GW, the at least one PDU may further include sending, by the first DP GW to the second DP GW, multiple PDUs including the multiple request segments.

In some aspects, mapping, by the second DP GW, the request to the second request further may include reassembling, by the second DP GW, the multiple PDUs to obtain the request.

In some aspects, the request may include a first set of identifiers (IDs) based on the first service-based interface format of the caller, the first set of IDs indicating one or more of: the procedure, and the parameter of the procedure. The second request may include a second set of IDs based on the second service-based interface format of the callee, the second set of IDs indicating one or more of: the procedure, and the parameter of the procedure.

In some aspects, the method may further include receiving, by the least one DP GW from the callee, a response based on the second service-based interface format, the response indicating one or more of: a result of the procedure and a result value. In some aspects, the method may further include sending, by the at least one DP GW to the caller, a second response based on the first service-based interface format, the response indicating one or more of: the result of the procedure and the result value. The method may further include mapping, by the at least one DP GW, the response to the second response.

In some aspects, receiving, by the least one DP GW from the caller, a response may include receiving, by the at least one DP GW from the callee, at least one PDU including the response. In some aspects, mapping, by the at least one DP GW, the response to the second response may include mapping, by a third DP GW of the at least one DP GW, the response to the second response. In some aspects, sending, by the at least one DP GW to the caller, the second response may include sending, by the third DP GW to a fourth DP GW of the at least one DP GW, the at least one PDU including the second response.

In some aspects, mapping, by the at least one DP GW, the response to the second response may include sending, by a third DP GW of the at least one DP GW to a fourth DP GW of the at least one DP GW, the at least one PDU including the response. In some aspects, mapping, by the at least one DP GW, the response to the second response may further include mapping, by the fourth DP GW, the response to the second response.

In some aspects, sending, by the third DP GW to the fourth DP GW, the at least one PDU may include segmenting, by the third DP GW, the response into multiple response segments. In some aspects, sending, by the third DP GW to the fourth DP GW, the at least one PDU may further include sending, by the third DP GW to the fourth DP GW, multiple PDUs including the multiple response segments.

In some aspects, mapping, by the fourth DP GW, the response to the second response may further include reassembling, by the second DP GW, the multiple PDUs to obtain the request.

In some aspects, the response may include a third set of IDs based on the second service-based interface format of the callee, the third set of IDs indicating one or more of: the result of the procedure. In some aspects, the second response may include a fourth set of IDs based on the first service-based interface format of the caller, the fourth set of IDs indicating one or more of: the result of the procedure.

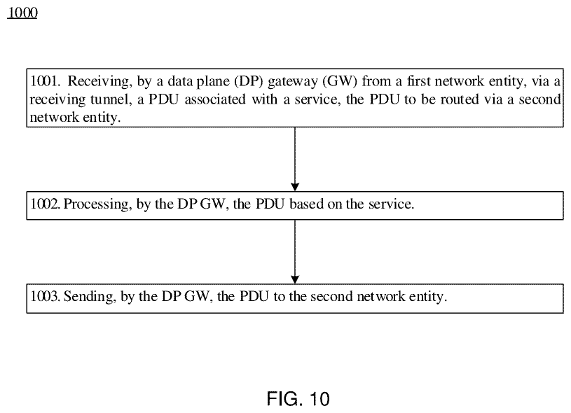

FIG. 10 illustrates another method for processing data, according to an aspect. The method 1000 may be performed by a DP GW (e.g., a RAN DP GW 314, 316, 414, 416, 514, 516, 518 or a CN DP GW 212, 542, 544, 546). The method 1000 includes receiving 1001, by a data plane (DP) gateway (GW) from a first network entity, via a receiving tunnel, a PDU associated with a service, the PDU to be routed via a second network entity. The method 1000 further includes processing 1002, by the DP GW, the PDU based on the service. The method 1000 further includes sending 1003, by the DP GW, the PDU to the second network entity.

In some aspects, the PDU may include a first L3 header. The first L3 header may include one or more of: a source address; a destination address; and a quality of service (QOS) information indicating one of: a class of the PDU, a priority of the PDU; and a QoS flow that the PDU belongs to.

In some aspects, the source address may indicate one of: an address of a sender of the PDU, an address of a radio access network (RAN) node to which the sender belongs to, an address of an originator of the PDU, and an address of a processing service. In some aspects, the destination address may be one of: an address of the DP GW, an address of a RAN node to which the DP GW belongs to, and an address of a processing service.

In some aspects, the PDU may further include a first L4 header, the first l4 header including a connection identifier (ID) identifying the receiving tunnel through which the PDU is received. In some aspects, the receiving tunnel may be associated with a processing service, the connection ID identifying a connection between an originator of the PDU and a final destination of the PDU. In some aspects, the receiving tunnel may be associated with a connectivity service that connects two network entities, the connection ID identifying a connection between the two network entities.

In some aspects, sending 1003, by the DP GW, the PDU to the second network entity may include determining, by the DP GW, a transmitting tunnel. In some aspects, sending 1003, by the DP GW, the PDU to the second network entity may further include sending, by the DP GW, the PDU to the second network entity via the transmitting tunnel.

In some aspects, the transmitting tunnel may be determined based on one of: a mapping between the receiving tunnel and the transmitting tunnel, a mapping between the connection ID and a second connection ID that identifies the transmitting tunnel, a mapping among the connection ID, the QoS information and the second connection ID, and a mapping provided by a network controller at the RAN.

In some aspects, the transmitting tunnel may include a sender end and a receiver end, the sender end being the DP GW and the receiver end being the second network entity.

In some aspects, the DP GW may be a central unit (CU) in a RAN DP (e.g., CU-DP, 314, 414 and 514), and the PDU may be associated with a processing service. In some aspects, the receiving tunnel may be a T3 tunnel (e.g., T3 303, 403, and 503). In some aspects, the transmitting tunnel may be an M2 tunnel (e.g., M2 402 and 502). In some aspects, the receiver end of the transmitting tunnel may be a RAN DP GW (e.g., DP GW 416, 516, 518).

In some aspects, the PDU may be associated with a processing service. The receiving tunnel may be an M2 tunnel (e.g., M2 402 and 502). The transmitting tunnel may be a T3 tunnel (e.g., T3 303, 403, and 503). The receiver end of the transmitting tunnel may be a core network (CN) DP GW (e.g., NPF 212, 542).

In some aspects, the PDU may be associated with a connectivity service. The receiving tunnel may be a T3 tunnel (e.g., T3 303, 403, and 503). The transmitting tunnel may be a data radio bearer (DRB) (e.g., DRB 307, 407) associated with a device. The receiver end of the transmitting tunnel may be the device 102.

In some aspects, the DP GW may be a processing unit (PU) in a RAN DP (e.g., PU 316, 416, 516, 518) and the PDU may be associated with a processing service. The receiving tunnel may be one of: a T3 tunnel (e.g., T3 303, 403, and 503), an M2 tunnel (e.g., M2 402 and 502), an M5 tunnel (e.g., M5 305, 405, and 505). In some aspects, the transmitting tunnel may be an M4 tunnel (e.g., 304, 404, and 504). Ins some aspects, the receiver end of the transmitting tunnel may be a RAN DP GW (e.g., DP GW 316, 416, 516, 518).

In some aspects, the receiving tunnel may be one of: a T3 tunnel (e.g., T3 303, 403, and 503), an M2 tunnel (e.g., M2 402 and 502), an M4 tunnel (e.g., M4 304, 404, and 504), and an M5 tunnel (e.g., M5 305, 405, and 505). In some aspects, the transmitting tunnel may be a processing radio bearer (XRB) (e.g., XRB 308, and 408) associated with a device. The receiver end of the transmitting tunnel may be the device.

In some aspects, the receiving tunnel may be one of: a T3 tunnel (e.g., T3 303, 403, and 503), an M2 tunnel (e.g., M2 402 and 502), and an M4 tunnel (e.g., M4 304, 404, and 504). In some aspects, the transmitting tunnel may be an M5 tunnel (e.g., M5 305, 405, and 505). In some aspects, the receiver end of the transmitting tunnel may be a RAN processing service function (PSF) (e.g., RAN PSF 322, 422, 520, 522, 524 and 526).

In some aspects, the method 1000 may further include processing, by the DP GW, the PDU to obtain a modified PDU. In some aspects, sending 1003, by the DP GW, the PDU to the second network entity via the transmitting tunnel may include sending, by the DP GW, the modified PDU to the second network entity via the transmitting tunnel.

In some aspects, processing, by the DP GW, the PDU to obtain a modified PDU may include one of: replacing the first L3 header with a second L3 header, modifying the first L3 header into the second L3 header. In some aspects, the second L3 header may include one or more of: a second source address, a second destination address, a second QoS information.

In some aspects, the second source address may be one of: a same address as the source address in the first L3 header, a different address than the source address in the first L3 header, an address of a RAN DP GW, an address of a processing service from which the PDU originated.

In some aspects, the second destination address may be one of: a same address as the destination address in the first L3 header, a different address than the destination address in the first L3 header, an address of the receiving end of the transmitting tunnel, an address of a processing service wherein the PDU is targeting the processing service, an address of a device wherein the transmitting tunnel is a radio bearer associated with the device.

In some aspects, the second QoS information may be is one of: the same as the QoS information in the first L3 header, different from the QoS information in the first L3 header.

In some aspects, processing, by the DP GW, the PDU to obtain a modified PDU further may include one of: replacing the first L4 header with a second L4 header, and modifying the first L4 header into the second L4 header. In some aspects, the second L4 header may include a third connection ID, the third connection ID being one or more of: different from the connection ID in the first L4 header, an ID identifying the transmitting tunnel, and the second connection ID.

In some aspects, the transmitting tunnel may be associated with a processing service, and the third connection ID identifies a connection between an originator of the PDU and a final destination of the PDU. In some aspects, the transmitting tunnel may be associated with a connectivity service that connects two network entities, and the connection ID identifies a connection between the two network entities.

In some aspects, the receiving tunnel may be a radio bearer associated with a device, the radio bearer being one of: a data radio bearer (DRB) and a processing radio bearer (XRB). In some aspects, the PDU may include a first L3 header, the first L3 header including one or more of: a source address; a destination address; and a quality of service (QOS) information indicating one of: a class of the PDU, a priority of the PDU and a QoS flow that the PDU belongs to.

In some aspects, the source address may indicate an address of an originator of the PDU, the originator being the device. In some cases, the destination address may be one of: an address of a processing service or an address of a processing service function (PSF) that provides at least part of the processing service if: the receiving tunnel is associated with the processing service, the receiving tunnel is the XRB, or the PDU is targeting the processing service. In some cases, the destination address may be one of: an address of the DP GW or an address of a radio access network (RAN) node to which the DP GW belongs to.

In some aspects, the method 1000 may further include a first L4 header, the first l4 header including a connection identifier (ID) identifying the receiving tunnel through which the PDU is received.

In some aspects, the connection ID may identify a connection between the device and a processing service. In some aspects, the connection ID may identify a connection between the device and a PSF that provides at least part of the processing service if: the receiving tunnel is associated with a processing service, the receiving tunnel is the XRB that the device uses to access the processing service, or the PDU is associated with the processing service.

In some aspects, the connection ID may identify a connection between the device and a DN. In some aspects, the connection ID may identify a connection between the device and an application server of the DN if: the receiving tunnel is associated with a connectivity service, the receiving tunnel is a DRB that the device uses to access the connectivity service, or the PDU is associated with the connectivity service, wherein the connectivity service connects the device to the DN or the AS.

In some aspects, sending 1003, by the DP GW, the PDU to the second network entity may include determining, by the DP GW, a transmitting tunnel. In some aspects, sending 1003, by the DP GW, the PDU to the second network entity may further include sending, by the DP GW, the PDU to the second network entity via the transmitting tunnel.

In some aspects, the transmitting tunnel may be determined based on one of: a mapping between the receiving tunnel and the transmitting tunnel, a mapping between the connection ID and a second connection ID that identifies the transmitting tunnel, a mapping among the connection ID, the QoS information and the second connection ID, and a mapping provided by a network controller at the RAN.

In some aspects, the transmitting tunnel may include a sender end and a receiver end, the sender end being the DP GW. In some aspects, the DP GW may be a central unit (CU) in a RAN DP (e.g., CU-DP 314, 414 and 514). In some aspects, the PDU may be associated with a connectivity service, and the transmitting tunnel may be a T3 tunnel (e.g., T3 303, 403, and 503). The receiver end of the transmitting tunnel may be a core network (CN) DP GW in a CN DP (e.g., NPF 212, 542). The second network entity may be the receiver end of the transmitting tunnel.

In some aspects, the DP GW may be a processing unit (PU) in a RAN DP (e.g., PU 316, 416, 516, 518). Where the PDU is associated with a processing service, the transmitting tunnel may be one of: an M2 tunnel (e.g., M2 402 and 502), an M4 tunnel (e.g., M4 304, 404, and 504), or an M5 tunnel (e.g., M5 305, 405, and 505).

In some aspects, the transmitting tunnel is a T3 tunnel (e.g., T3 303, 403, and 503), and the receiver end of the transmitting tunnel may be a core network (CN) DP GW in a CN DP (e.g., NPF 212, 542), and the second network entity is the receiver end of the transmitting tunnel.

In some aspect, the transmitting tunnel is an M2 tunnel (e.g., M2 402 and 502), and the receiving end of the transmitting tunnel is a central unit (CU) in the RAN DP (e.g., CU-DP 314, 414 and 514), and the second network entity is the receiver end of the transmitting tunnel.

In some aspects, the transmitting tunnel is an M4 tunnel (e.g., M4 304, 404, and 504), the receiver end of the transmitting tunnel may be another PU, and the another PU is communicatively coupled with a processing service function (PSF) in the RAN that provides at least in part the processing service. In some aspects, the transmitting tunnel is an M4 tunnel (e.g., M4 304, 404, and 504), the second network entity may be the receiver end of the transmitting tunnel.

In some aspects, the transmitting tunnel is an M5 tunnel (e.g., M5 305, 405, and 505), the receiver end of the transmitting tunnel may be a RAN processing service function (PSF) (e.g., RAN PSF 322, 422, 520, 522, 524 and 526). The RAN PSF providing at least in part the processing service. In some aspects, the transmitting tunnel is an M5 tunnel (e.g., M5 305, 405, and 505), the second network entity is the receiver end of the transmitting tunnel.

In some aspects, the method 1000 may further include processing, by the DP GW, the PDU to obtain a modified PDU. In some aspects, sending 1003, by the DP GW, the PDU to the second network entity via the transmitting tunnel may include sending, by the DP GW, the modified PDU to the second network entity via the transmitting tunnel.

In some aspects, processing, by the DP GW, the PDU to obtain a modified PDU may include one of: replacing the first L3 header with a second L3 header, and modifying the first L3 header into the second L3 header. In some aspects, the second L3 header may include a second source address, the second source address being one of: a same address as the source address in the first L3 header, a different address than the source address in the first L3 header, an address of the DP GW.

In some aspects, the second L3 header may further include a second destination address, the second destination address being one of: a same address as the destination address in the first L3 header, a different address than the destination address in the first L3 header, an address of the receiving end of the transmitting tunnel, an address of a processing service function that provides at least part of a processing service wherein the PDU is targeting the processing service.

In some aspects, the second L3 header may further include a second QoS information, the second QoS information being one of: the same as the QoS information in the first L3 header, different from the QoS information in the first L3 header.

In some aspects, processing, by the DP GW, the PDU to obtain a modified PDU may further includes one of: replacing the first L4 header with a second L4 header, modifying the first L4 header into the second L4 header. In some aspects, the second L4 header may be a tunnel header of the transmitting tunnel.

In some aspects, the second L4 header may include a third connection ID, the third connection ID being one or more of: different from the connection ID in the first L4 header; an ID identifying the transmitting tunnel; and the second connection ID.

In some aspects, the DP GW is a core network (CN) DP GW (e.g., NPF 212, 542). The receiver end of the receiving tunnel may be the CN DP GW, and a sender end of the receiving tunnel may be at one of: a RAN, a CN, and a DN.

In some aspects, the PDU may include a first L3 header, the first L3 header including one or more of: a source address and a destination address. In some aspects, the source address may indicate one of: an address of the sender end, an address of a RAN node to which the sender end belongs, an address of an originator, and an address of a processing service from where the PDU originated.

In some aspects, the destination address may be one of: an address of the CN DP GW, and an address of a processing service if the PDU is targeting the processing service.

In some aspects, the PDU may further include a QoS information indicating one of: a class of the PDU, a priority of the PDU, and a QoS flow that the PDU belongs to.

In some aspects, the PDU may further include a first L4 header, the first l4 header including a connection ID identifying a receiving tunnel through which the PDU is received.

In some aspects, the connection ID may identify a connection between the originator of the PDU and a final destination of the PDU if: the receiving tunnel is associated to a processing service or the PDU is associated to a processing service. In some aspects, the connection ID may identify a connection between two network entities if: the receiving tunnel or the PDU is associated with a connectivity service, the connectivity service connecting the two network entities.

In some aspects, sending 1003, by the DP GW, the PDU to the second network entity may include determining, by the CN DP GW, a transmitting tunnel. In some aspects, sending 1003, by the DP GW, the PDU to the second network entity may further include sending, by the CN DP GW, the PDU to the second network entity via the transmitting tunnel.

In some aspects, the transmitting tunnel may be determined based on one of: a mapping between the receiving tunnel and the transmitting tunnel, a mapping between the connection ID and a second connection ID that identifies the transmitting tunnel, a mapping among the connection ID, the QoS information and the second connection ID, and a mapping provided by a network controller at the CN.

In some aspects, the transmitting tunnel may include a sender end and a receiver end, the sender end being the CN DP GW, the receiver end being in one of: the RAN, the CN, and the DN.

In some aspects, the transmitting tunnel is a T3 tunnel (e.g., T3 303, 403, and 503), and the receiver end of the transmitting tunnel may be a RAN DP GW in a RAN DP (e.g., DP GW 316, 416, 516, 518), and the second network entity is the receiver end of the transmitting tunnel.

In some aspects, the transmitting tunnel is a T4 tunnel (e.g., T4 204, 554), and the receiver end of the transmitting tunnel is another CN DP GW in a RAN DP, and the second network entity is the receiver end of the transmitting tunnel.

In some aspects, the PDU is associated with a processing service and the transmitting tunnel is a T5 tunnel (e.g., T5 205 and 555), the receiver end of the transmitting tunnel may be a CN processing service function (PSF) that provides at least in part the processing service. In such cases, the second network entity may be the receiver end of the transmitting tunnel.

In some aspects, the transmitting tunnel is a T6 tunnel (e.g., T6 206, 556), and the receiver end of the transmitting tunnel is in a DN 130, and the second network entity may be the receiver end of the transmitting tunnel.

In some aspects, the method 1000 may further include processing, by the CN DP GW, the PDU to obtain a modified PDU. In some aspects, sending, by the CN DP GW, the PDU to the second network entity via the transmitting tunnel may include: sending, by the CN DP GW, the modified PDU to the second network entity via the transmitting tunnel.

In some aspects, processing, by the CN DP GW, the PDU to obtain a modified PDU includes one of: replacing the first L3 header with a second L3 header, modifying the first L3 header into the second L3 header.

In some aspects, the second L3 header may include a second source address, the second source address being one of: a same address as the source address in the first L3 header, a different address than the source address in the first L3 header, an address of the CN DP GW, an address of an originator of the PDU, and an address of a processing services if the PDU originated from a processing service.

In some aspects, the second L3 header may further include a second destination address, the second destination address being one of: a same address as the destination address in the first L3 header, a different address than the destination address in the first L3 header, an address of the receiving end of the transmitting tunnel, an address of a processing service function that provides at least part of a processing service if the PDU is targeting the processing service.

In some aspects, the second L3 header may further include a second Qos information, the second QoS information being one of: the same as the QoS information in the first L3 header or different from the QoS information in the first L3 header.

In some aspects, processing, by the CN DP GW, the PDU to obtain a modified PDU may further include replacing the first L4 header with a second L4 header. In some aspects, processing, by the CN DP GW, the PDU to obtain a modified PDU may further include modifying the first L4 header into the second L4 header, where the second L4 header is a tunnel header of the transmitting tunnel.

In some aspects, the second L4 header may include a third connection ID, the third connection ID being one or more of: different from the connection ID in the first L4 header, an ID identifying the transmitting tunnel, and the second connection ID.

In some aspects, the third connection ID may identify a connection between an originator of the PDU and a final destination of the PDU if: the transmitting tunnel or the PDU is associated with a processing service. In some aspects, the third connection ID may identify a connection between two network entities if: the transmitting tunnel or the PDU is associated with a connectivity service that connects the two network entities.

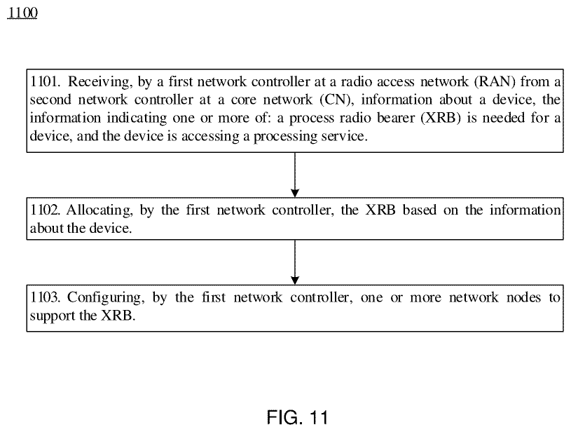

FIG. 11 illustrates a method for allocating a radio bearer for a device, according to an aspect. The method 1100 may be similar to the method 700. According to another aspect, method 1100 includes receiving 1101, by a first network controller (e.g., network controller 710) at a radio access network (RAN) from a second network controller (e.g., network controller 712 at a core network (CN), information about a device 102. The information may indicate one or more of: a process radio bearer (XRB) is needed for a device, and the device is accessing a processing service. In some aspects, the method 1100 may further include allocating 1102, by the first network controller, the XRB based on the information about the device. In some aspects, the method 1100 further includes configuring 1103, by the first network controller, one or more network nodes to support the XRB.

In some aspects, allocating 1102, by the first network controller, the XRB based on the information about the device may include generating an ID to identify the XRB. In some aspects, configuring 1103, by the first network controller, one or more network nodes to support the XRB may include configuring, by the first network controller, a RAN data plane (DP) gateway (GW) associated with the XRB.

In some aspects, the RAN DP GW is a processing unit (PU) (e.g., PU 316, 416, 516, 518). In some aspects, configuring, by the first network controller, the RAN DP GW may include: providing, by the first network controller to the PU, the generated ID. In some aspects, configuring, by the first network controller, the RAN DP GW may further include configuring, by the first network controller, the PU to disable the XRB to perform one or more of: PDCP security, and PDCP sequencing.

In some aspects, configuring 1103, by the first network controller, one or more network nodes to support the XRB may further include configuring, by the first network controller, a distributed unit (DU) associated with the XRB.

In some aspects, configuring, by the first network controller, the DU associated with the XRB may include providing, by the first network controller to the DU, the generated ID. In some aspects, configuring, by the first network controller, the DU associated with the XRB may further include configuring, by the first network controller, the DU to disable the XRB to perform one or more of: RLC segmentation, and RLC acknowledgement.

In some aspects, configuring 1103, by the first network controller, one or more network nodes to support the XRB may further includes configuring, by the first network controller, the device to support the XRB.

In some aspects, configuring, by the first network controller, the device to support the XRB may include providing, by the first network controller to the device, the generated ID. In some aspects, configuring, by the first network controller, the device to support the XRB may further include configuring, by the first network controller, the device to disable the XRB to perform one or more of: RLC segmentation, RLC acknowledgement, PDCP security, and PDCP sequencing.

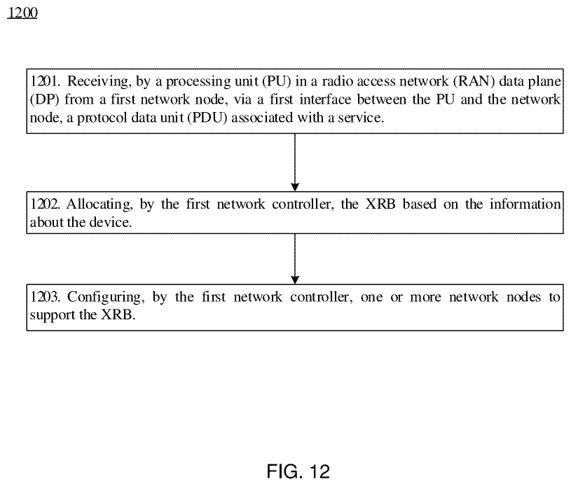

FIG. 12 illustrate another method of processing data, according to an aspect. The method 1200 may include receiving 1201, by a processing unit (PU) in a radio access network (RAN) data plane (DP) from a first network node, via a first interface between the PU and the network node, a protocol data unit (PDU) associated with a service. In some aspect, the PU in RAN may refer to any one of PU 316, 416, 516, 518. In some aspect, the method 1200 may further include processing 1202, by the PU, the PDU to obtain a processed PDU. In some aspect, the method 1200 may further include sending 1203, by the PU to a second network node, via a second interface between the PU and the second network node, the processed PDU.

In some aspect, the first network node is the device, and the first interface may be one of: a data radio bearer (e.g., DRB 307 and 407) and a processing radio bearer (e.g., XRB 308, and 408).

In some aspects, the second network node and the second interface may respectfully be one of: another PU in the RAN DP and an M4 interface (e.g., M4 304, 404, and 504), a PU backend in the RAN DP (e.g., PU-BE 322, 422, 520, 522, 524, 526) and an M5 interface (e.g., M5 305, 405, and 505), a central unit (CU) in the RAN DP (e.g., CU-DP 314, 414 and 514) and an M2 interface (e.g., M2 402 and 502), a DP gateway (GW) in a core network (CN) DP (e.g., NPF 212, 542) and a T3 interface (e.g., T3 303, 403, and 503).

In some aspects, the first network node is another PU in the RAN DP, and the first interface may be an M4 interface (e.g., M4 304, 404, and 504). In some aspects, the second network node and the second interface may be respectfully one of: the device 102 and a data radio bearer (e.g., DRB 307 and 407), the device 102 and a processing radio bearer (e.g., XRB 308, and 408), a PU backend in the RAN DP (e.g., PU-BE 322, 422, 520, 522, 524, 526) and an M5 interface (e.g., M5 305, 405, and 505), a central unit (CU) in the RAN DP (e.g., CU-DP 314, 414 and 514) and an M2 interface (e.g., M2 402 and 502), and a DP gateway (GW) in a core network (CN) DP (e.g., NPF 212, 542) and a T3 interface (e.g., T3 303, 403, and 503).

In some aspect, the first network node is a PU backend in the RAN DP (e.g., PU-BE 322, 422, 520, 522, 524, 526), and the first interface is an M5 interface (e.g., M5 305, 405, and 505). In some aspects, the second network node and the second interface may respectfully be one of: the device 102 and a data radio bearer (e.g., DRB 307 and 407), the device 102 and a processing radio bearer (e.g., XRB 308, and 408), another PU in the RAN DP and an M4 interface (e.g., M4 304, 404, and 504), a central unit (CU) in the RAN DP (e.g., CU-DP 314, 414 and 514) and an M2 interface (e.g., M2 402 and 502), and a DP gateway (GW) in a core network (CN) DP (e.g., NPF 212, 542) and a T3 interface (e.g., T3 303, 403, and 503).

In some aspects, the first network node is a central unit (CU) in the RAN DP (e.g., CU-DP 314, 414 and 514), and the first interface is an M2 interface (e.g., M2 402 and 502). In some aspects, the second network node and the second interface may respectfully be one of: the device 102 and a data radio bearer (e.g., DRB 307 and 407), the device 102 and a processing radio bearer (e.g., XRB 308, and 408), another PU in the RAN DP and an M4 interface (e.g., M4 304, 404, and 504), a PU backend in the RAN DP (e.g., PU 316, 416, 516, 518) and an M5 interface (e.g., M5 305, 405, and 505), and a DP gateway (GW) in a core network (CN) DP (e.g., NPF 212, 542) and a T3 interface (e.g., T3 303, 403, and 503).

In some aspects, the first network node may be a DP gateway (GW) in a core network (CN) DP (e.g., NPF 212, 542), and the first interface is a T3 interface (e.g., T3 303, 403, and 503). The second network node and the second interface may respectfully be one of: the device 102 and a data radio bearer (e.g., DRB 307 and 407), the device 102 and a processing radio bearer (e.g., XRB 308, and 408), another PU in the RAN DP and an M4 interface (e.g., M4 304, 404, and 504), a PU backend in the RAN DP and an M5 interface (e.g., M5 305, 405, and 505), and a central unit (CU) in the RAN DP (e.g., CU-DP 314, 414 and 514) and an M2 interface (e.g., M2 402 and 502).

Aspects of the present disclosure can be implemented using electronics hardware, software, or a combination thereof. In some aspects, this may be is implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific aspects of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding aspects, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disc read-only memory (CD-ROM), USB flash disk, or a removable hard disk. The software product includes a number of instructions that enable a computer device (personal computer, server, or network device) to execute the methods provided in the aspects of the present invention. For example, such an execution may correspond to a simulation of the logical operations as described herein. The software product may additionally or alternatively include a number of instructions that enable a computer device to execute operations for configuring or programming a digital logic apparatus in accordance with aspects of the present invention.

Although the present invention has been described with reference to specific features and aspects thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method comprising:
receiving, by a first network controller at a radio access network (RAN) from a second network controller at a core network (CN), information about a device, the information indicating one or more of: a process radio bearer (XRB) is needed for the device or the device is accessing a processing service;
allocating, by the first network controller, the XRB based on the information about the device; and
configuring, by the first network controller, one or more network nodes to support the XRB.

2. The method of claim 1, wherein the allocating, by the first network controller, the XRB based on the information about the device comprises:
generating an identifier (ID) to identify the XRB.

3. The method of claim 1, wherein the configuring, by the first network controller, the one or more network nodes to support the XRB comprises:
configuring, by the first network controller, a RAN data plane (DP) gateway (GW) associated with the XRB.

4. The method of claim 3, wherein:
the RAN DP GW is a processing unit (PU), and
the configuring, by the first network controller, the RAN DP GW comprises:
providing, by the first network controller to the PU, an ID to identify the XRB; and
configuring, by the first network controller, the PU to disable the XRB to perform one or more of: packet data convergence protocol (PDCP) security or PDCP sequencing.

5. The method of claim 1, wherein the configuring, by the first network controller, the one or more network nodes to support the XRB further comprises:
configuring, by the first network controller, a distributed unit (DU) associated with the XRB.

6. The method of claim 5, wherein the configuring, by the first network controller, the DU associated with the XRB comprises:
providing, by the first network controller to the DU, an ID to identify the XRB; and
configuring, by the first network controller, the DU to disable the XRB to perform one or more of: radio link control (RLC) segmentation or RLC acknowledgement.

7. The method of claim 1, wherein the configuring, by the first network controller, the one or more network nodes to support the XRB further comprises:
configuring, by the first network controller, the device to support the XRB.

8. The method of claim 7, wherein the configuring, by the first network controller, the device to support the XRB comprises:
providing, by the first network controller to the device, an ID to identify the XRB; and
configuring, by the first network controller, the device to disable the XRB to perform one or more of: RLC segmentation, RLC acknowledgement, PDCP security, or PDCP sequencing.

9. An apparatus comprising:
at least one processor; and
at least one machine-readable medium storing executable instructions which when executed by the at least one processor cause the apparatus to perform:
receiving, from a second network controller at a core network (CN), information about a device, the information indicating one or more of: a process radio bearer (XRB) is needed for the device, and the device is accessing a processing service,
wherein the apparatus is or is part of a first network controller at a radio access network (RAN);
allocating the XRB based on the information about the device; and
configuring one or more network nodes to support the XRB.

10. The apparatus of claim 9, wherein the allocating the XRB comprises:
generating an identifier (ID) to identify the XRB.

11. The apparatus of claim 9, wherein the configuring the one or more network nodes comprises:
configuring a RAN data plane (DP) gateway (GW) associated with the XRB.

12. The apparatus of claim 11, wherein:
the RAN DP GW is a processing unit (PU), and
the configuring the RAN DP GW comprises:
providing, to the PU, an ID to identify the XRB; and
configuring the PU to disable the XRB to perform one or more of: packet data convergence protocol (PDCP) security or PDCP sequencing.

13. The apparatus of claim 9, wherein the configuring the one or more network nodes comprises:
configuring, a distributed unit (DU) associated with the XRB.

14. The apparatus of claim 13, wherein the configuring the DU comprises:
providing, to the DU, an ID identify the XRB; and
configuring, the DU to disable the XRB to perform one or more of: radio link control (RLC) segmentation or RLC acknowledgement.

15. The apparatus of claim 9, wherein the configuring the one or more network nodes comprises:
configuring the device to support the XRB.

16. The apparatus of claim 9, wherein the configuring the device comprises:
providing, to the device, an ID to identify the XRB; and
configuring the device to disable the XRB to perform one or more of: RLC segmentation, RLC acknowledgement, PDCP security or PDCP sequencing.

17. A non-transitory computer readable medium having instructions stored thereon which, when executed by a first network controller at a radio access network (RAN), cause the first network controller to perform:
receiving, from a second network controller at a core network (CN), information about a device, the information indicating one or more of: a process radio bearer (XRB) is needed for the device or the device is accessing a processing service;
allocating the XRB based on the information about the device; and
configuring one or more network nodes to support the XRB.

18. The non-transitory computer readable medium of claim 17, wherein the allocating the XRB comprises:
generating an identifier (ID) to identify the XRB.

19. The non-transitory computer readable medium of claim 17, wherein the configuring the one or more network nodes comprises:
configuring a RAN data plane (DP) gateway (GW) associated with the XRB.

20. The non-transitory computer readable medium of claim 17, wherein the configuring the one or more network nodes comprises:
configuring a distributed unit (DU) associated with the XRB.
